(19) United States
(12) Patent Application Publication
(10) Pub. No.: US 2025/0078091 A1
(43) Pub. Date: Mar. 6, 2025

(54) SYSTEMS AND METHODS FOR INTELLIGENT AND CONTINUOUS RESPONSIBLE AI COMPLIANCE AND GOVERNANCE MANAGEMENT IN AI PRODUCTS

(71) Applicant: Accenture Global Solutions Limited, Dublin 4 (IE)

(72) Inventors: Emmanuel Munguia Tapia, San Jose, CA (US); Abhishek Mukherji, Fremont, CA (US); Aishwarya Satish Padmanabhan, Santa Clara, CA (US); Fnu Shashi, San Jose, CA (US); Yatin Bajaj, Delhi (IN); Molly Carrene Cho, San Jose, CA (US); Jayashree Subrahmonia, San Jose, CA (US); Nure Alam, Bhabhua (IN); Sathyapriya Sambath Kumar, Chennai (IN)

(73) Assignee: Accenture Global Solutions Limited, Dublin 4 (IE)

(21) Appl. No.: 18/241,078

(22) Filed: Aug. 31, 2023

(51) Int. Cl. G06Q 30/018; G06N 5/022; G06Q 30/0203

(52) U.S. Cl. CPC G06Q 30/018; G06N 5/022; G06Q 30/0203

(57) ABSTRACT

Systems and methods for responsible AI compliance and governance management in AI Products are disclosed. The system receives a request to assess an enterprise product associated with a specific application. Further, the system may determine a plurality of datasets associated with the AI model of the enterprise product. Furthermore, the system generates a training dataset and a test dataset for the determined plurality of datasets associated with the AI model. The system generates a ranked list of recommended metrics for the enterprise product based on the generated training dataset and the test dataset. The system further determines a mitigation strategy for the enterprise product based on the generated ranked list of recommended metrics. Furthermore, the system creates a feedback loop for continuous training and tuning the AI model and the plurality of datasets based on the determined mitigation strategy.

### TECHNICAL FIELD

The present disclosure generally relates artificial intelligence systems and, more specifically, relates to systems and methods for Intelligent and Continuous Responsible AI (RAI) compliance and governance management in AI products.

### BACKGROUND

With the advent of artificial intelligence (AI) driven solutions for organizations, regulating and monitoring the AI driven solutions have been a major challenge in the industry. AI driven solutions may include a plurality of AI models and training datasets. These plurality of AI models and the training datasets may require a large amount of assessment and evaluation periodically for ensuring a quality output. Generally, organizations using the AI driven solutions fail to implement stringent data quality checks to ensure quality of the AI models and the training datasets. Rather, AI driven solutions are usually evaluated, regulated and monitored with model performance being a primary metric. Therefore, other dimensions of the AI models such as data bias accuracy, model accuracy, model explainability, along with eight dimensions of the responsible AI. The eight dimensions of the responsible AI may include soundness, fairness, transparency, accountability, robustness, privacy, sustainability, liability and compliance are not typically considered for evaluation of the AI driven solutions. This may lead to inaccurate outputs from the AI driven solutions. Further, existing evaluation approaches for AI driven solutions may fail to update the AI driven solutions constantly based on changing governance or geography specific regulations. When the AI driven solutions fail to comply with these regulations, the organizations may encounter consequences, such as brand damage and customer backlash. To avoid such consequences, the organizations may have to constantly update the AI driven solutions in order to comply with these regulations.

An example of the AI driven solutions may include a generative AI algorithm. Organizations may use the generative AI algorithms to comply with the regulations. However, the generative AI algorithms may generate incorrect outputs. Such outputs may lead to the consequences described above. Furthermore, the training datasets used for training the AI models are often extracted from diverse sources. Such training datasets may include inherent variables and implicit incorrect factors or biases which may not be adequately measured before or after a model development. This may lead to inaccurate AI model learning that leads to inappropriate human decision making.

Therefore, there is a need for an improved system and methods for intelligent and continuous responsible AI compliance and governance management in AI Products by dynamically monitoring and governing quality of the AI driven solutions within the organizations according to the eight responsible AI dimensions

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for intelligent and continuous responsible AI compliance and governance management in AI Products The system receives a request to assess an enterprise product associated with a specific application. The request includes an artificial intelligence (AI) model or models, initial information and a metadata associated with the enterprise product. The metadata may include geographic region, technology tech stack, people responsible for the assessment, and the like. Further, the system determines a plurality of datasets associated with the AI model of the enterprise product. The plurality of datasets include a plurality of attributes and protected groups within the plurality of datasets. Furthermore, the system generates a training dataset and a test dataset for the determined plurality of datasets associated with the AI model or models, the trained dataset and the test dataset includes an expanded trained dataset and a classified test dataset. The training dataset and the test dataset includes an expanded training dataset and a classified test dataset. The system further generates a ranked list of recommended metrics for the enterprise product based on the generated training dataset and the test dataset and historical information on similar products in functional area previously evaluated. The ranked list of recommended metrics is generated in order of relevancy. The system further determines a mitigation strategy for the enterprise product based on the generated ranked list of recommended metrics, and historical data of previously remediated solutions in similar functional areas and regions. The mitigation strategy includes a remediation recommendation including a list of ranked remediation steps for the enterprise product with effort scores, re-selected datasets, and re-trained models. Furthermore, the system creates a feedback loop for continuous training and tuning the AI model and the plurality of datasets based on the determined mitigation strategy.

In another aspect, the present disclosure relates to a method for intelligent and continuous responsible AI compliance and governance management in AI Products. The method includes receiving, by a processor, a request to assess an enterprise product associated with a specific application. The requests include an artificial intelligence (AI) model or models, initial information and a metadata associated with the enterprise product. The metadata may include a functional area, a geographic region, technology tech stack, people responsible for the assessment, and the like. Further, the method includes determining, by the processor, a plurality of datasets associated with the AI model of the enterprise product. The plurality of datasets include a plurality of attributes and protected groups within the plurality of datasets. Furthermore, the method includes generating, by the processor, a training dataset and a test dataset for the determined plurality of datasets associated with the AI model or models. The trained dataset and the test dataset includes an expanded trained dataset and a classified test dataset. The method further includes generating, by the processor, a ranked list of recommended metrics for the enterprise product based on the generated training dataset and the test dataset and historical information on similar products in functional area previous evaluated. The ranked list of recommended metrics is generated in order of relevancy. Furthermore, the method includes determining, by the processor, a mitigation strategy for the enterprise product based on the generated ranked list of recommended metrics and historical data of previously remediated solutions in similar functional areas and regions. The mitigation strategy includes a remediation recommendation comprising a list of ranked remediation steps for the enterprise product with effort scores, re-selected datasets, and re-trained models. Additionally, the method includes creating, by the processor, a feedback loop for continuous training and tuning the AI model and the plurality of datasets based on the determined mitigation strategy.

In another aspect, the present disclosure relates to a non-transitory computer readable medium comprising a processor-executable instructions that cause a processor to receive a request to assess an enterprise product associated with a specific application. The request includes an artificial intelligence (AI) model or models, initial information and a metadata associated with the enterprise product. The metadata may include a functional area, a geographic region, a technology stack people responsible for the assessment, and the like. Further, the processor determines a plurality of datasets associated with the AI model of the enterprise product. The plurality of datasets include a plurality of attributes and protected groups within the plurality of datasets. Furthermore, the processor generates a training dataset and a test dataset for the determined plurality of datasets associated with the AI model or models, the trained dataset and the test dataset includes an expanded trained dataset and a classified test dataset. The training dataset and the test dataset includes an expanded training dataset and a classified test dataset. The processor further generates a ranked list of recommended metrics for the enterprise product based on the generated training dataset and the test dataset and historical information on similar products in functional area previous evaluated. The ranked list of recommended metrics is generated in order of relevancy. The processor further determines a mitigation strategy for the enterprise product based on the generated ranked list of recommended metrics and historical data of previously remediated solutions in similar functional areas and regions. The mitigation strategy includes a remediation recommendation including a list of ranked remediation steps for the enterprise product with effort scores, re-selected datasets, and re-trained models. Furthermore, the processor creates a feedback loop for continuous training and tuning the AI model and the plurality of datasets based on the determined mitigation strategy.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings include the invention of electrical components, electronic components or circuitry commonly used to implement such components.

FIG. 1 illustrates an exemplary block diagram representation of a network architecture in which a system may be implemented for intelligent and continuous responsible AI compliance and governance management in AI Products, in accordance with embodiments of the present disclosure.

FIG. 2 illustrates an exemplary block diagram representation of a computer-implemented the system, such as those shown in FIG. 1, capable of intelligent and continuous responsible AI compliance and governance management in AI Products, in accordance with embodiments of the present disclosure.

FIG. 3 illustrates an example block diagram depicting a detailed view of the computing environment such as those shown in FIG. 1, capable of managing compliance and governance, in accordance with embodiments of the present disclosure.

FIG. 4A illustrates an example block diagram representation of the system, such as those shown in FIG. 1, capable of monitoring compliance and governance, in accordance with embodiments of the present disclosure.

FIG. 4B depicts a block diagram of a dataset ingestion module, such as those shown in FIG. 3 and FIG. 4A, in accordance with embodiments of the present disclosure.

FIG. 4C depicts an example API design created by the dataset ingestion module for a plurality of types of file formats, in accordance with embodiments of the present disclosure.

FIG. 4D depicts a block diagram illustrating an example process of training an API for a given input by the dataset ingestion module, in accordance with embodiments of the present disclosure.

FIG. 4E depicts a block diagram illustrating an example process of predicting an API for a given input by the dataset ingestion module, in accordance with embodiments of the present disclosure.

FIG. 4F depicts a block diagram illustrating an example process of generating metrics metadata API for a given input by the dataset ingestion module, in accordance with embodiments of the present disclosure.

FIG. 4G depicts a block diagram illustrating an example process of computing RAI metrics for a given input by the dataset ingestion module, in accordance with embodiments of the present disclosure.

FIG. 4H is a process flowchart illustrating an example method of generating the training dataset and the test dataset for the determined plurality of datasets associated with the AI model, in accordance with embodiments of the present disclosure.

FIG. 4I depicts a graphical representation of a density based clustering and synthetic sample generation, in accordance with embodiments of the present disclosure.

FIG. 4J depicts a block diagram illustrating an example process of expanding and splitting dataset by the dataset ingestion module, in accordance with embodiments of the present disclosure.

FIG. 4K is a process flowchart illustrating an example method of generating the training dataset and the test dataset for the determined plurality of datasets associated with the AI model, in accordance with embodiments of the present disclosure.

FIG. 4L depicts a block diagram illustrating an example process of generating a filtered training dataset by the dataset ingestion module, in accordance with embodiments of the present disclosure.

FIG. 4M depicts a schematic representation of a context-based model recommendation module, such as those shown in FIG. 3 and FIG. 4A, in accordance with embodiments of the present disclosure.

FIG. 4N is a process flowchart illustrating an example method of recommending a best match AI model, in accordance with embodiments of the present disclosure.

FIG. 5A is a block diagram of an optimal model finder, such as those shown in FIG. 4A, in accordance with embodiments of the present disclosure.

FIG. 5B is a process flowchart illustrating an example method of generating a ranked list of recommended metrics for the enterprise product, in accordance with embodiments of the present disclosure.

FIG. 5C is a block diagram of a metrics recommendation engine, in accordance with embodiments of the present disclosure.

FIG. 5D is a process flowchart illustrating an example method of generating an RAI metrics report, in accordance with embodiments of the present disclosure.

FIG. 5E depicts a RAI metrics report generator module, such as those shown in FIG. 3, in accordance with embodiments of the present disclosure.

FIG. 5F is a process flowchart illustrating an example method of determine the mitigation strategy for the enterprise product based on the generated report, in accordance with embodiments of the present disclosure.

FIG. 5G depicts a block diagram of a RAI report generator and mitigation classifier module, in accordance with embodiments of the present disclosure.

FIG. 5H depicts a block diagram of a RAI automatic remediator module, in accordance with embodiments of the present disclosure.

FIG. 5I is a process flowchart depicting a method of evaluating the enterprise product by a RAI questionnaire recommender module, in accordance with embodiments of the present disclosure.

FIG. 6 illustrates an exemplary flow diagram representation of a method for managing a RAI product governance lifecycle in an enterprise, in accordance with embodiments of the present disclosure.

FIG. 7 illustrates an exemplary flow diagram representation of a method for generating AI based risk assessment report, in accordance with embodiments of the present disclosure.

FIG. 8 illustrates an exemplary block diagram representation of functions of a RAI framework, in accordance with an embodiment of the present disclosure, in accordance with embodiments of the present disclosure.

FIG. 9 illustrates an exemplary block diagram representation of a hardware platform for implementation of the disclosed system, in accordance with embodiments of the present disclosure.

FIG. 10 illustrates a flow chart depicting a method of intelligent and continuous responsible AI compliance and governance management in AI Products, in accordance with embodiments of the present disclosure.

FIG. 11 illustrates an exemplary flow diagram representation of RAI product assessment, in accordance with embodiments of the present disclosure.

FIG. 12 illustrates an exemplary reference architecture diagram of an RAI assessment, in accordance with embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a system and a method for intelligent and continuous responsible AI compliance and governance management in AI Products. The system receives a request to assess an enterprise product associated with a specific application. The request includes initial information and a metadata associated with the enterprise product such as functional area, geographic region, technology stack among others, and an artificial intelligence (AI) model (or models). Further, the system determines a plurality of datasets associated with the AI model of the enterprise product. The plurality of datasets include a plurality of attributes and protected groups within the plurality of datasets. Furthermore, the system generates a training dataset and a test dataset for the determined plurality of datasets associated with the AI model, the trained dataset and the test dataset includes an expanded trained dataset and a classified test dataset. The training dataset and the test dataset includes an expanded training dataset and a classified test dataset. The system further generates a ranked list of recommended metrics for the enterprise product based on the generated training dataset and the test dataset and historical information on similar products in functional area previous evaluated. The ranked list of recommended metrics is generated in order of relevancy. The system further determines a mitigation strategy for the enterprise product based on the generated ranked list of recommended metrics and historical data of previously remediated solutions in similar functional areas and regions. The mitigation strategy includes a remediation recommendation including a list of ranked remediation steps for the enterprise product with effort scores, re-selected datasets, and re-trained models. Furthermore, the system creates a feedback loop for continuous training and tuning the AI model and the plurality of datasets based on the determined mitigation strategy.

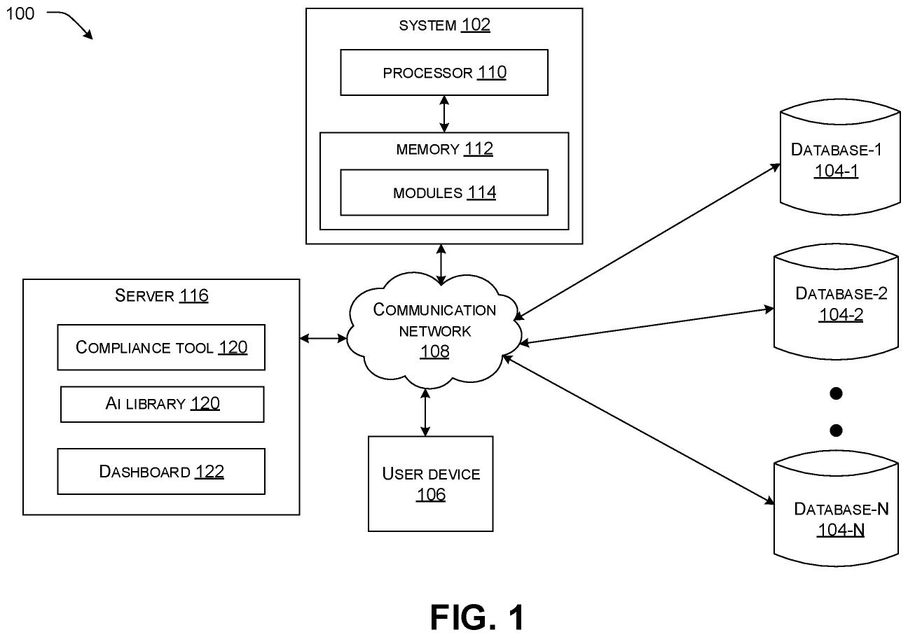

Referring now to the drawings, and more particularly to FIG. 1 through FIG. 12, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 in which a system 102 may be implemented for intelligent and continuous responsible AI compliance and governance management in AI Products, in accordance with embodiments of the present disclosure. The network architecture 100 may include the system 102, one or more databases 104-1, 104-2, . . . , and 104-N (individually referred to as the database 104, and collectively referred to as the databases 104), a user device 106, and a server 116. The server 116 may be, but are not limited to, a cloud server, a centralized server, a rack server, a network server, a computer-based server, on premise server, a dedicated server, a remote server, and the like. The server 116 may include a compliance tool 120, an AI library 120, and a dashboard 122. The system 102, and the server 116 may be communicatively coupled to the user device 106 via a communication network 108. The communication network 108 may be a wired communication network and/or a wireless communication network.

Further, the user device 106 may be associated with, but not limited to, a user, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102. The user device 106 may present to the user one or more user interfaces for the user to interact with the system 102 for responsible AI compliance and governance management in AI Products needs. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. Further, the system 102 may include one or more processor(s) 110, and a memory 112. The memory 112 may include a plurality of modules 114. The system 102 may be a hardware device including the processor 110 executing machine-readable program instructions for intelligent and continuous responsible AI compliance and governance management in AI Products. Execution of the machine-readable program instructions by the processor 110 may enable the proposed system 102 to perform responsible AI compliance and governance management. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more processors 110 may include, for example, microprocessors, microcomputers, microcontrollers, digital signal processors, central processing units, state machines, logic circuits, and/or any devices that manipulate data or signals based on operational instructions. Among other capabilities, the processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, Bluetooth adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may receive a request to assess an enterprise product associated with a specific application. In an exemplary embodiment, the request includes, but are not limited to, an artificial intelligence (AI) model, initial information, a metadata associated with the enterprise product, and the like. The metadata may include geographic region, technology tech stack, people responsible for the assessment, and the like. The AI model may be any AI model known in the art. The initial information may be. Further, the metadata associated with the enterprise product may include. In an exemplary embodiment, the enterprise products may be AI solutions used by the enterprises for responsible AI compliance and governance management in AI Products. Alternatively, the enterprise products may include any other products used by the enterprises for managing the compliance and governance. The specific application of the enterprise product may include a domain area or a functional area, such as for example, human resources (HR), finance and the like. As a first step, the system uses the metadata information such as functional area and geographic region to automatically generate a risk assessment questionnaire from a library questions. This questionnaire is answered by the product manager and AI lead and the risk scoring engine produces a report with a risk score for the application.

In an exemplary embodiment, the system 102 may determine a plurality of datasets associated with the AI model of the enterprise product. In an embodiment, the plurality of datasets may include a plurality of attributes and protected groups within the plurality of datasets. The plurality of attributes may include features of the dataset, target value for ground truth, and the like.

In an exemplary embodiment, the system 102 may generate a training dataset and a test dataset for the determined plurality of datasets associated with the AI model. In an exemplary embodiment, the training dataset and the test dataset includes an expanded training dataset and a classified test dataset.

In an exemplary embodiment, the system 102 may generate a ranked list of recommended metrics for the enterprise product based on the generated training dataset and the test dataset and historical information on similar products in functional area previously evaluated. In an exemplary embodiment, the ranked list of recommended metrics may be generated in order of relevancy.

In an exemplary embodiment, the system 102 may determine a mitigation strategy for the enterprise product based on the generated ranked list of recommended metrics and historical data of previously remediated solutions in similar functional areas and regions. In an exemplary embodiment, the mitigation strategy includes, but is not limited to, a remediation recommendation including a list of ranked remediation steps for the enterprise product with effort scores, re-selected datasets, re-trained models, and the like. The effort scores may include high, medium, and low effort. The effort scores range from 0-100. The thresholds depend on application and are configurable.

In an exemplary embodiment, the system 102 may create a feedback loop for continuous training and tuning the AI model and the plurality of datasets based on the determined mitigation strategy. Finally, the application generates a report that is communicated to the compliance tool of the organization by means of controls. Controls are threshold rules defined over risk scores and responsible AI metrics selected to be applied to the product. Once the thresholds comply with the thresholds defined at the organization level, product can go into production. Similarly, if the product has been put into production and the continuous feedback monitoring of the system in production produces thresholds below the controls specified at the organization level, then the system is put in pause until the corresponding thresholds are fixed or improved upon.

In an exemplary embodiment, the system 102 may further generate a report for the enterprise product based on the generated ranked list of recommended metrics. The report includes, but are not limited to, one of the recommended metrics, dashboard configurations, project comparisons, and mitigation options, and the like. In an exemplary embodiment, the system 102 may generate a product assessment report for the enterprise product based on the determined mitigation strategy and the generated report. The product assessment report includes product quality indicators, and the like. In an exemplary embodiment, the system 102 may output the generated report, the determined mitigation strategy, and the generated product assessment report for the enterprise product on a user interface of the user device 106. In an exemplary embodiment, the system 102 may retrieve a metadata associated with the AI model from a database 104. The metadata includes, but are not limited to, an application domain, a data size, a feature variable type, a model used, documentation information, and the like. In an example embodiment, if the dataset contains a feature that is age, then the feature variable data type may be an integer and if the feature is a gender, then the feature variable data type may be a string and so on.

In an exemplary embodiment, the system 102 may compute a similarity metric score between current enterprise product and historical records of enterprise products based on the retrieved metadata. In an exemplary embodiment, the similarity score may be a cosine similarity/Jacquard similarity. The metric used depends on the application. The similarity score may be 0 to 1 or converted to a percentage. In an exemplary embodiment, the system 102 may determine a plurality of recommendations for the AI model based on the computed similarity metric score using a collaborative filtering process and a content-based filtering process. The collaborative filtering process and the content based filtering process may include, for example, but not limited to a LibRecommender which is a collaborative filtering process and a Pandas library for the content based filtering In an exemplary embodiment, the system 102 may identify a list of similar AI models based on the determined plurality of recommendations. In an exemplary embodiment, the system 102 may identify similarity features mapping relevantly with each of the identified list of similar AI models based on acceptance of the identified list of similar AI models. In an exemplary embodiment, the system 102 may identify a subset of metadata associated with each of the list of similar AI models based on the identified similarity features. In an exemplary embodiment, the system 102 may execute a distance technique for each of the identified subset of metadata associated with each of the list of similar AI models. The distance may be the opposite of the similarities. The distance reflects the reverse of similarity. They are inversely proportional to each other. In an exemplary embodiment, the system 102 may determine at least one AI model as recommended AI model among the list of similar AI models based on results of execution of the distance technique. In an exemplary embodiment, the system 102 may generate a metadata for the determined at least one AI model.

In an exemplary embodiment, to determine the at least one AI model as recommended AI model for the enterprise product, the system 102 may retrieve a plurality of AI models stored in the database 104. In an exemplary embodiment, the system 102 may extract a metadata associated with each of the retrieved plurality of AI models. The metadata includes, but is not limited to, performance metrics, model fairness level, explainability level, a dataset size, a model dimensionality, a memory resource, and the like. In an exemplary embodiment, the system 102 may determine an appropriate AI model among the retrieved plurality of AI models by applying the extracted metadata to each of the retrieved plurality of AI models.

In an exemplary embodiment, to generate the training dataset and the test dataset for the determined plurality of datasets associated with the AI model, the system 102 may eliminate target variables present in the determined plurality of datasets. The target variables are the variables in the dataset that is a ground truth for prediction in the data model. In an exemplary embodiment, the system 102 may perform clustering on the determined plurality of datasets based on the plurality of attributes and the protected groups within the determined plurality of datasets. In an exemplary embodiment, the system 102 may assign a density score to each cluster of datasets based on a set of parameters. The density score may be available as results for the clustering of the output. A clustering algorithm provides the density of the scores indicative of the number of samples within the given radius from the centroid of a cluster. In an exemplary embodiment, the system 102 may map the assigned density score and a deviation level with a predefined threshold value. In an exemplary embodiment, the system 102 may generate synthetic data samples for the cluster of datasets based on the mapped density score and the deviation level. The synthetic data samples are simulated data samples with semantically similar data of the actual data. These data samples mimic the different variations in the data. In an exemplary embodiment, the system 102 may select n percentage of the test dataset from a centroid of each cluster for each of the protected groups. In an exemplary embodiment, the system 102 may recompute density scores for expanded training dataset based on the selected n percentage of the test dataset. In an exemplary embodiment, the system 102 may compare the recomputed density scores with the predefined threshold value. In an exemplary embodiment, the system 102 may generate the expanded training dataset and the classified test dataset upon determining that the recomputed density scores are lower than the predefined threshold value. In an exemplary embodiment, the system 102 may repeat the steps from generating the synthetic data samples upon determining that the recomputed density scores are greater than the predefined threshold value.

In an exemplary embodiment, to generate the training dataset and the test dataset for the determined plurality of datasets associated with the AI model by, the system 102 may identify AI detectors to be factored from the determined plurality of datasets based on the specific application. In an exemplary embodiment, the system 102 may determine a threshold value for each of the identified AI detectors. In an exemplary embodiment, the system 102 may compute an average overall compliance score by applying the plurality of datasets to each of the identified AI detectors. In an exemplary embodiment, the system 102 may identify a compliance rectification strategy by comparing the computed average overall compliance score with the determined threshold value of each of the identified AI detectors. In an exemplary embodiment, the system 102 may perform one of a modification and an elimination of K data samples upon determining that the computed average overall compliance score is less than the compliance threshold value based on the identified rectification strategy. In an exemplary embodiment, the system 102 may generate a filtered training dataset associated with the AI model based on the performed one of the modifications and the elimination.

In an exemplary embodiment, to generate the ranked list of recommended metrics for the enterprise product based on the generated training dataset and the test dataset and historical information on similar products in functional area previously evaluated, the system 102 may determine domain-specific fairness metrics for the generated training dataset and the test dataset from a metric library. Further, the system 102 may evaluate a feasibility value of applying the determined domain specific fairness metrics to the plurality of datasets based on the plurality of attributes and the protected groups within the plurality of datasets. The feasibility value suggests a binary value which may be high, medium and low. In an exemplary embodiment, the system 102 may assign weights to the determined domain specific fairness metrics based on results of the evaluation. Furthermore, the system 102 may compute a composite score for the determined domain-specific fairness metrics by correlating the assigned weights with corresponding domain specific fairness metric. The composite score may be an aggregated weighted average score derived from the individual metric scores. In an exemplary embodiment, the system 102 may map each of the computed composite score with a predefined threshold value. Also, the system 102 may perform bootstrap resampling to the determined domain-specific fairness metrics based on results of mapping. The results of bootstrap resampling generate a bootstrap sample.

In an exemplary embodiment, the system 102 may compute the domain-specific fairness metrics and a composite score for each of the bootstrap sample. Every domain or every application may have different fairness metrics. These are computed based on the application and type of model that is being evaluated. In an exemplary embodiment, the system 102 may determine a mean value of the computed composite score. The determined mean value is mapped with the predefined threshold value. In an exemplary embodiment, the system 102 may compute an ensemble metric score for each of the bootstrap sample based on results of the mapping. In an exemplary embodiment, the system 102 may generate the ranked list of recommended metrics for the enterprise product based on the computed ensemble metric score.

In an exemplary embodiment, to determine the mitigation strategy for the enterprise product based on the generated report, the system 102 may determine, but are not limited to, the recommended metrics, the dashboard configurations, the project comparisons, the mitigation options from the generated report, and the like. In an exemplary embodiment, the system 102 may generate dashboard views for the determined recommended metrics based on the dashboard configurations. Further, the system 102 may create dashboard descriptions for the generated dashboard views using pre-stored rules. In an exemplary embodiment, the system 102 may generate a similarity score for each of pre-stored similar enterprise products. The pre-stored similar products are determined using similarity metric between the current enterprise product and pre-stored enterprise products.

In an exemplary embodiment, the system 102 may map the generated similarity score for each of the pre-stored similar enterprise products with a predefined threshold value. In an exemplary embodiment, the system 102 may generate remediation outputs for the pre-stored similar enterprise products based on results of mapping. In an exemplary embodiment, the system 102 may apply the created dashboard descriptions, and the generated remediation outputs to a generative AI model. In an exemplary embodiment, the system 102 may generate a remediation list based on results of the generative AI model. Further, the system 102 may classify the generated remediation list into an automated task and a manual task. Furthermore, the system 102 may trigger automatic pipelines for dataset splitting and model training based on the classified automated task and the manual task. In an exemplary embodiment, an automated task retrains the model with a different feature list. The manual task may be to get more annotated data samples for a given target variable. In an exemplary embodiment, the system 102 may generate a remediated metrics report for the enterprise product based on the triggered automatic pipelines and the generated remediation list.

In an exemplary embodiment, to evaluate the enterprise product, the system 102 may determine a functional and a sub-functional area of the enterprise product. Further, the system 102 may identify responsible AI (RAI) dimensions required for recommending the questionnaire based on the determined functional and sub-functional area of the enterprise product. In an exemplary embodiment, the system 102 may recommend questions based on the identified RAI dimensions using an AI questionnaire model. The AI questionnaire model comprises pre-stored questions. In an exemplary embodiment, the system 102 may generate relating questions to the recommended questions using a generative AI model. In an exemplary embodiment, the system 102 may evaluate an AI model and a dataset associated with the enterprise product based on the generated remediation recommendation and the generated report comprising the recommended metrics.

In an exemplary embodiment, to evaluate the AI model and the dataset, the system 102 may compare each of the recommended metrics with a pre-defined control metrics. Further, the system 102 may determining a risk associated with the recommended metrics based on the results of comparison. The results of comparison comprise mapped metrics and un-mapped metrics. The risk associated with recommended metrics may be high, medium, low based on risk score from 0-100 In an exemplary embodiment, the system 102 may generate an AI based risk assessment report for the enterprise product based on the determined risk. The AI based risk report comprises corrective actions to rectify the determined risk. The corrective actions may include, for example, but not limited to, documentation, metric definition (Threshold where applicable), metric evaluation (Previously validation), metric improvement, test case(s) definition, data collection, test case(s) evaluation, methodology(s) definition, methodology(s) implementation, methodology(s) testing, model retraining, role assignment/identification, expert consultation, dataset quality validation, data understanding, license verification, code review/scan and the like.

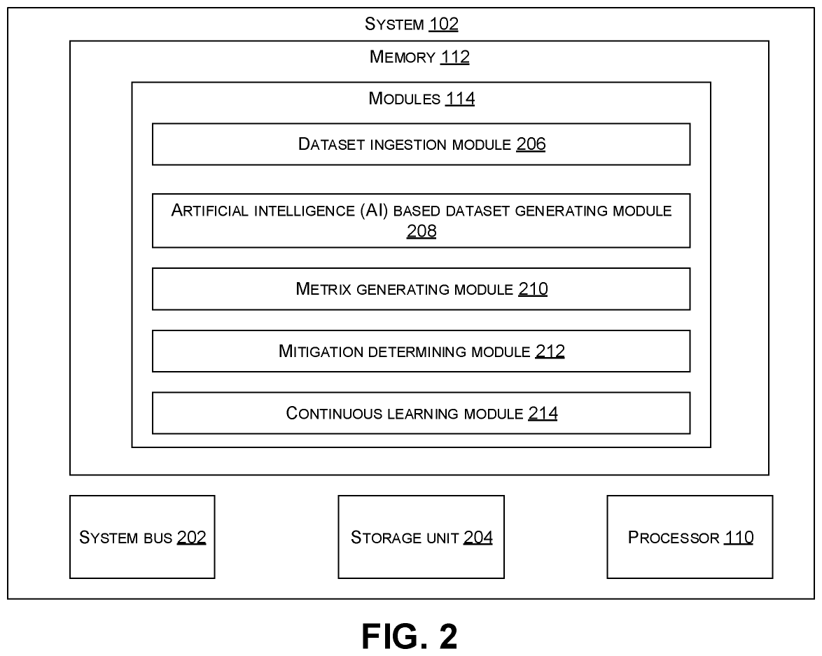

FIG. 2 illustrates an exemplary block diagram representation of a computer-implemented the system 102, such as those shown in FIG. 1, capable of intelligent and continuous responsible AI compliance and governance management in AI Products, in accordance with embodiments of the present disclosure. The system 102 may also function as a computer-implemented system 102. The system 102 may include the one or more processors 110, the memory 112, and a storage unit 204. The one or more processors 110, the memory 112, and the storage unit 204 are communicatively coupled through a system bus 202 or any similar mechanism. The memory 112 comprises a plurality of modules 114 in a form of programmable instructions executable by the one or more processors 110.

Further, the plurality of modules 114 include a dataset ingestion module 206, an artificial intelligence (AI) based dataset generating module 208, a metrics generating module 210, a mitigation determining module 212, and a continuous learning module 214.

The one or more processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 may include the plurality of modules 114 stored in the form of machine-readable instructions on any of the above-mentioned storage media and may be in communication with and executed by the one or more processors 110.

The storage unit 204 may be a cloud storage or a database such as those shown in FIG. 1. The storage unit 204 may store, but is not limited to, metadata, plurality of datasets, training dataset, test dataset, classified test dataset, expanded training dataset, a classified test dataset, ranked list of recommended metrics, mitigation strategy, enterprise product, effort scores, re-selected datasets, re-trained models, performance metrics, model fairness level, explainability level, a dataset size, a model dimensionality, and a memory resource, plurality of AI models, K data samples, automatic pipelines for dataset any other data, and combinations thereof. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the dataset ingestion module 206 may receive a request to assess an enterprise product associated with a specific application. In an exemplary embodiment, the request includes, but are not limited to, an artificial intelligence (AI) model, initial information, a metadata associated with the enterprise product, and the like. The metadata may include geographic region, technology tech stack, people responsible for the assessment, and the like. In an exemplary embodiment, the artificial intelligence (AI) based dataset generating module 208 may determine a plurality of datasets associated with the AI model of the enterprise product. In an embodiment, the plurality of datasets include a plurality of attributes and protected groups within the plurality of datasets.

In an exemplary embodiment, the artificial intelligence (AI) based dataset generating module 208 may generate a training dataset and a test dataset for the determined plurality of datasets associated with the AI model. In an exemplary embodiment, the training dataset and the test dataset includes an expanded training dataset and a classified test dataset.

In an exemplary embodiment, the metrics generating module 210 may generate a ranked list of recommended metrics for the enterprise product based on the generated training dataset and the test dataset and historical information on similar products in functional area previously evaluated. In an exemplary embodiment, the ranked list of recommended metrics may be generated in order of relevancy.

In an exemplary embodiment, the mitigation determining module 212 may determine a mitigation strategy for the enterprise product based on the generated ranked list of recommended metrics and historical data of previously remediated solutions in similar functional areas and regions. In an exemplary embodiment, the mitigation strategy includes, but is not limited to, a remediation recommendation including a list of ranked remediation steps for the enterprise product with effort scores, re-selected datasets, re-trained models, and the like.

In an exemplary embodiment, the continuous learning module 214 may create a feedback loop for continuous training and tuning the AI model and the plurality of datasets based on the determined mitigation strategy.

In an exemplary embodiment, the processor 110 may further generate a report for the enterprise product based on the generated ranked list of recommended metrics. The report includes, but are not limited to, one of the recommended metrics, dashboard configurations, project comparisons, and mitigation options, and the like. In an exemplary embodiment, the processor 110 may generate a product assessment report for the enterprise product based on the determined mitigation strategy and the generated report. The product assessment report includes product quality indicators, and the like. In an exemplary embodiment, the processor 110 may output the generated report, the determined mitigation strategy, and the generated product assessment report for the enterprise product on a user interface of the user device 106. In an exemplary embodiment, the processor 110 may retrieve a metadata associated with the AI model from a database 104. The metadata includes, but are not limited to, an application domain, a data size, a feature variable type, a model used, documentation information, and the like.

In an exemplary embodiment, the processor 110 may compute a similarity metric score between current enterprise product and historical records of enterprise products based on the retrieved metadata. In an exemplary embodiment, the processor 110 may determine a plurality of recommendations for the AI model based on the computed similarity metric score using a collaborative filtering process and a content-based filtering process. In an exemplary embodiment, the processor 110 may identify a list of similar AI models based on the determined plurality of recommendations. In an exemplary embodiment, the processor 110 may identify similarity features mapping relevantly with each of the identified list of similar AI models based on acceptance of the identified list of similar AI models. In an exemplary embodiment, the processor 110 may identify a subset of metadata associated with each of the list of similar AI models based on the identified similarity features. In an exemplary embodiment, the processor 110 may execute a distance technique for each of the identified subset of metadata associated with each of the list of similar AI models. In an exemplary embodiment, the processor 110 may determine at least one AI model as recommended AI model among the list of similar AI models based on results of execution of the distance technique. In an exemplary embodiment, the processor 110 may generate a metadata for the determined at least one AI model.

In an exemplary embodiment, to determine the at least one AI model as recommended AI model for the enterprise product, the processor 110 may retrieve a plurality of AI models stored in the database 104. In an exemplary embodiment, the processor 110 may extract a metadata associated with each of the retrieved plurality of AI models. The metadata includes, but is not limited to, performance metrics, model fairness level, explainability level, a dataset size, a model dimensionality, a memory resource, and the like. In an exemplary embodiment, the processor 110 may determine an appropriate AI model among the retrieved plurality of AI models by applying the extracted metadata to each of the retrieved plurality of AI models.

In an exemplary embodiment, to generate the training dataset and the test dataset for the determined plurality of datasets associated with the AI model, the processor 110 may eliminate target variables present in the determined plurality of datasets. In an exemplary embodiment, the processor 110 may perform clustering on the determined plurality of datasets based on the plurality of attributes and the protected groups within the determined plurality of datasets. In an exemplary embodiment, the processor 110 may assign a density score to each cluster of datasets based on a set of parameters. In an exemplary embodiment, the processor 110 may map the assigned density score and a deviation level with a predefined threshold value. In an exemplary embodiment, the processor 110 may generate synthetic data samples for the cluster of datasets based on the mapped density score and the deviation level. In an exemplary embodiment, the processor 110 may select n percentage of the test dataset from a centroid of each cluster for each of the protected groups. In an exemplary embodiment, the processor 110 may recompute density scores for expanded training dataset based on the selected n percentage of the test dataset. In an exemplary embodiment, the processor 110 may compare the recomputed density scores with the predefined threshold value. In an exemplary embodiment, the processor 110 may generate the expanded training dataset and the classified test dataset upon determining that the recomputed density scores are lower than the predefined threshold value. In an exemplary embodiment, the processor 110 may repeat the steps from generating the synthetic data samples upon determining that the recomputed density scores are greater than the predefined threshold value.

In an exemplary embodiment, to generate the training dataset and the test dataset for the determined plurality of datasets associated with the AI model, the processor 110 may identify AI detectors to be factored from the determined plurality of datasets based on the specific application. In an exemplary embodiment, the processor 110 may determine a threshold value for each of the identified AI detectors. In an exemplary embodiment, the processor 110 may compute an average overall compliance score by applying the plurality of datasets to each of the identified AI detectors. In an exemplary embodiment, the processor 110 may identify a compliance rectification strategy by comparing the computed average overall compliance score with the determined threshold value of each of the identified AI detectors. In an exemplary embodiment, the processor 110 may perform one of a modification and an elimination of K data samples upon determining that the computed average overall compliance score is less than the compliance threshold value based on the identified rectification strategy. In an exemplary embodiment, the processor 110 may generate a filtered training dataset associated with the AI model based on the performed one of the modifications and the elimination.

In an exemplary embodiment, to generate the ranked list of recommended metrics for the enterprise product based on the generated training dataset and the test dataset and historical information on similar products in functional area previously evaluated, the processor 110 may determine domain-specific fairness metrics for the generated training dataset and the test dataset from a metric library. Further, the processor 110 may evaluate a feasibility value of applying the determined domain specific fairness metrics to the plurality of datasets based on the plurality of attributes and the protected groups within the plurality of datasets. In an exemplary embodiment, the processor 110 may assign weights to the determined domain specific fairness metrics based on results of the evaluation. Furthermore, the processor 110 may compute a composite score for the determined domain-specific fairness metrics by correlating the assigned weights with corresponding domain specific fairness metric. In an exemplary embodiment, the processor 110 may map each of the computed composite score with a predefined threshold value. Also, the processor 110 may perform bootstrap resampling to the determined domain-specific fairness metrics based on results of mapping. The results of bootstrap resampling generate a bootstrap sample.

In an exemplary embodiment, the processor 110 may compute the domain-specific fairness metrics and a composite score for each of the bootstrap sample. In an exemplary embodiment, the processor 110 may determine a mean value of the computed composite score. The determined mean value is mapped with the predefined threshold value. In an exemplary embodiment, the processor 110 may compute an ensemble metric score for each of the bootstrap sample based on results of the mapping. In an exemplary embodiment, the processor 110 may generate the ranked list of recommended metrics for the enterprise product based on the computed ensemble metric score.

In an exemplary embodiment, to determine the mitigation strategy for the enterprise product based on the generated report, the processor 110 may determine, but are not limited to, the recommended metrics, the dashboard configurations, the project comparisons, the mitigation options from the generated report, and the like. In an exemplary embodiment, the processor 110 may generate dashboard views for the determined recommended metrics based on the dashboard configurations. Further, the processor 110 may create dashboard descriptions for the generated dashboard views using pre-stored rules. In an exemplary embodiment, the processor 110 may generate a similarity score for each of pre-stored similar enterprise products. The pre-stored similar products are determined using similarity metric between the current enterprise product and pre-stored enterprise products.

In an exemplary embodiment, the processor 110 may map the generated similarity score for each of the pre-stored similar enterprise products with a predefined threshold value. In an exemplary embodiment, the processor 110 may generate remediation outputs for the pre-stored similar enterprise products based on results of mapping. In an exemplary embodiment, the processor 110 may apply the created dashboard descriptions, and the generated remediation outputs to a generative AI model. In an exemplary embodiment, the processor 110 may generate a remediation list based on results of the generative AI model. Further, the processor 110 may classify the generated remediation list into an automated task and a manual task. Furthermore, the processor 110 may trigger automatic pipelines for dataset splitting and model training based on the classified automated task and the manual task. In an exemplary embodiment, the processor 110 may generate a remediated metrics report for the enterprise product based on the triggered automatic pipelines and the generated remediation list.

In an exemplary embodiment, to evaluate the enterprise product, the processor 110 may determine a functional and a sub-functional area of the enterprise product. Further, the processor 110 may identify responsible AI (RAI) dimensions required for recommending the questionnaire based on the determined functional and sub-functional area of the enterprise product. In an exemplary embodiment, the processor 110 may recommend questions based on the identified RAI dimensions using an AI questionnaire model. The AI questionnaire model comprises pre-stored questions. In an exemplary embodiment, the processor 110 may generate relating questions to the recommended questions using a generative AI model. In an exemplary embodiment, the processor 110 may evaluate an AI model and a dataset associated with the enterprise product based on the generated remediation recommendation and the generated report comprising the recommended metrics.

In an exemplary embodiment, to evaluate the AI model and the dataset, the processor 110 may compare each of the recommended metrics with a pre-defined control metrics. Further, the processor 110 may determine a risk associated with the recommended metrics based on the results of comparison. The results of comparison comprise mapped metrics and un-mapped metrics. In an exemplary embodiment, the processor 110 may generate an AI based risk assessment report for the enterprise product based on the determined risk. The AI based risk report comprises corrective actions to rectify the determined risk.

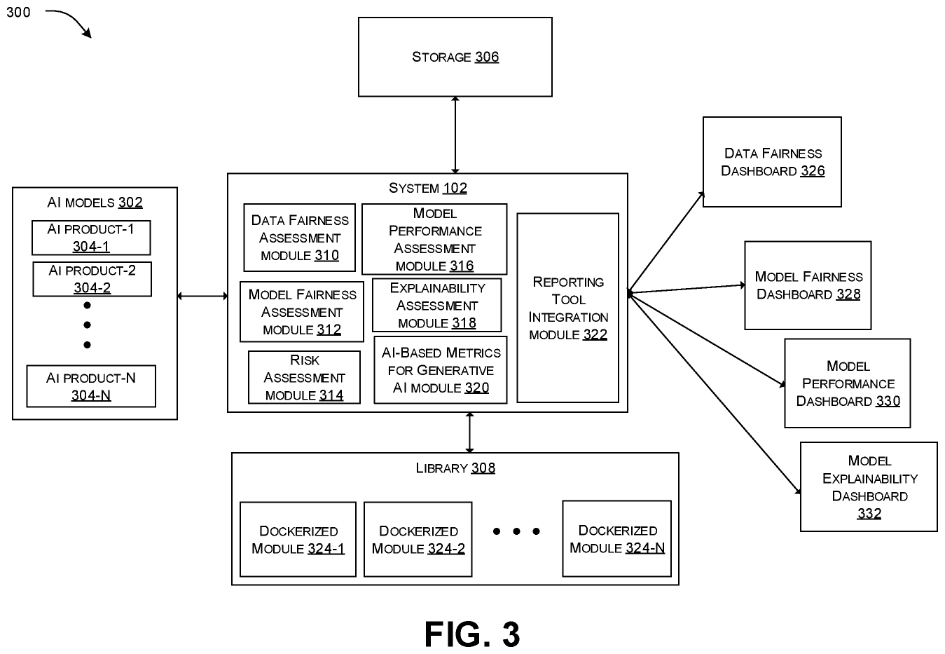

FIG. 3 illustrates an example block diagram depicting a detailed view of the computing environment 300 such as those shown in FIG. 1, capable of managing compliance and governance, in accordance with embodiments of the present disclosure.

In an example embodiment, a plurality of artificial intelligence (AI) models 302 may include a plurality of AI products 304-1, 304-2, 304-N (collectively referred to as the AI products 304, and individually referred to as the AI product 304). Each of the plurality of AI products 304 are fed at real-time to the system 102 as a train function universal resource locators (URLs) and a predict function URLs deployed in a container (not shown). The train function URLs and predict function URLs may be derived from, each of the plurality of AI models 302. Further, the training datasets and the test datasets are fed to the system 102 at real-time via an application programming interface (API) call. The location of the training datasets and the test datasets are provided as a URL to the system 102. The training datasets and the test datasets are stored in a storage 306. The storage 306 may include, but is not limited to, cloud storage or any other cloud storage mediums, and the like.

Further, as the AI models 302 are accessed via the train function URLs and test function URLs, all access to the source code and model may then be controlled by containerizing, hosting, and exposing the URLs. This eliminates the potential risk of exposing proprietary information. Additionally, users may test the AI models 302 more quickly and easily as the AI models 302 may not have to comply with any computing environment, software requirements, cloud requirements. In addition, with the independent and modular nature of containerization, standard, custom, and third-party models and metrics, each with their own implementation, environment, and software, may be combined into a cohesive library. Furthermore, as the AI models 302 are provided as containers to the system 102, the AI models 302 may be implemented in a plurality of technology stacks. The system 102 uses the AI models 302 irrespective of the technology stacks. Also, the container of the AI models 302 may be deployed anywhere such that the source code may not be made available to the system 102.

Further, the system 102 obtains metrics from a library 308 of responsible artificial intelligence (RAI) metrics and AI-based metrics for one or more large language models (LLMs). The library 308 may include dockerized modules 324-1, 324-2, . . . 324-N (collectively referred to as the dockerized modules 324, and individually referred to as the dockerized module 324) for explainability, fairness, and open-source implementation. Further, the system 102 may create and select an assessment project from the library 308. In an example embodiment, the metrics may be AI-based metrics. In an example embodiment, the library 308 includes a pre-built library of metrics, both conventional and AI based library of metrics for generative AI algorithms to evaluate the AI models 302 and associated data.

In an example embodiment, the system 102 may include a data fairness assessment module 310, a model fairness assessment module 312, a risk assessment module 314, a model performance assessment module 316, an explainability assessment module 318, an AI-based metrics for generative AI module 320, and a reporting tool integration module 322. The system 102 may execute the data fairness assessment module 310 to identify and eliminate discrimination in the training datasets and the test datasets. Further, system 102 may execute the data fairness assessment module 310 to identify diversity attributes and incorporate the diversity attributes in the training datasets and the test datasets. Further, data fairness assessment module may compute the configured data fairness metrics and return the computed metric results in the response.

In an example embodiment, the system 102 may execute the model fairness assessment module 312 to evaluate inaccuracy over answers of the AI models 302. For example, consider a benchmark including a well understood dataset composed of prompts (questions and answers) such as X and Y. The questions are then fed to a trained generative AI model to evaluate the outputs by comparing the current output with an expected output using a selected metrics. The metrics are selected from the library 308. The comparison of the answers, is semantic in nature and requires AI and natural language processing (NLP) techniques to appropriately assess the answers. Further, the model fairness assessment module 312 may continuously monitor fairness metrics of different AI models 302 in one framework.

In an example embodiment, the system 102 may execute the risks assessment module 314 to evaluate an AI model and a dataset associated with the AI product 304, based on the generated remediation recommendation and the generated report comprising the recommended metrics. The AI model 302 and the dataset are evaluated by comparing the recommended metrics with a pre-defined control metrics in an iterative process. Further, the risk assessment module 314 may evaluate the AI model 302 and the dataset, by determining a risk associated with the recommended metrics based on the results of comparison, the results of comparison comprise mapped metrics and un-mapped metrics. Also, the AI model and the dataset are evaluated by generating an AI based risk assessment report for the enterprise product based on the determined risk, the AI based risk report comprises corrective actions to rectify the determined risk. In an example embodiment, the risk assessment module 314 may assess risk via questionnaires created in the system 102 to evaluate risk over one or more RAI dimensions.

In an example embodiment, the system 102 may execute the model performance assessment module 316 to statically and continuously monitor the AI models 302 and provide performance metrics and visualization corresponding to the AI models 302.

In an example embodiment, the system 102 may execute the explainability assessment module 318 to provide insights on level of transparency of the solution (high, medium low) which may indicate the level of reasoning and evidence that is provided back to the user for the decisions taken by the AI model.

In an example embodiment, the system 102 may execute the artificial intelligence (AI) based metrics for generative AI module 320 to generate a ranked list of recommended metrics for the enterprise product based on the generated training dataset and the test dataset and historical information on similar products in functional area previously evaluated. The ranked list of recommended metrics may be generated in an order of relevancy. To generate the ranked list of recommended metrics for the enterprise product, the AI based metrics for generative AI module 320 may determine domain-specific fairness metrics for the generated training dataset and the test dataset from the library 308 such as a metric library. In an example embodiment, the domain-specific fairness metric may include, but not limited to, finance domain fairness metric, human resources domain fairness metric or any other domains. The domain specific fairness metric is determined by identifying, by the AI based metrics for generative AI module 320, application area or domain associated with each metrics stored in the library 308. Further, the AI based metrics for generative AI module 320 may evaluate feasibility value of applying the determined domain specific fairness metrics to the plurality of datasets based on the plurality of attributes and the protected groups within the plurality of datasets. The feasibility value may refer to a binary value for feasible/non feasible.

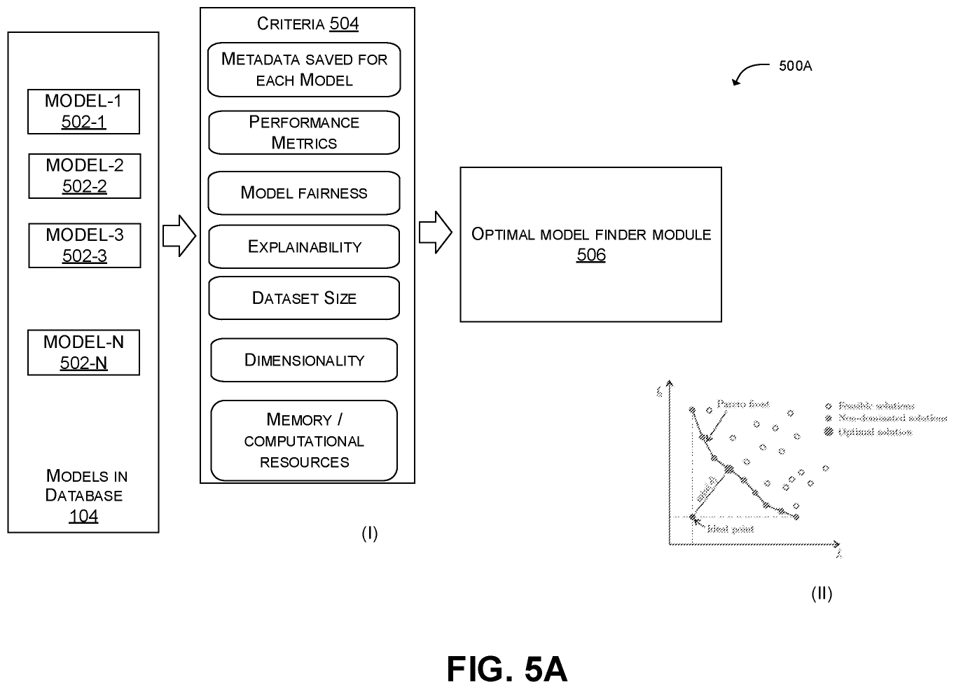

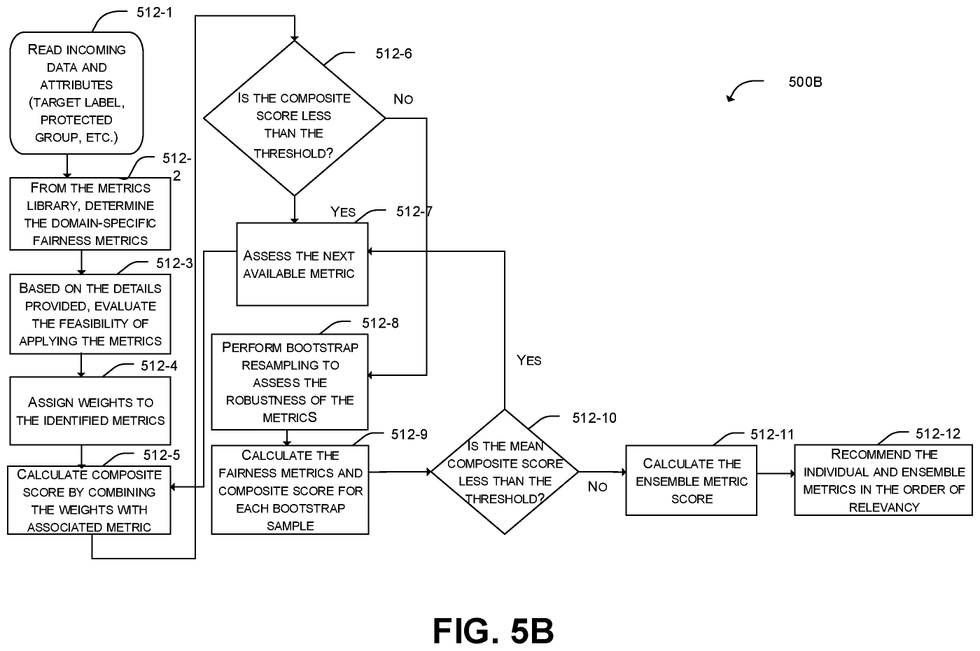

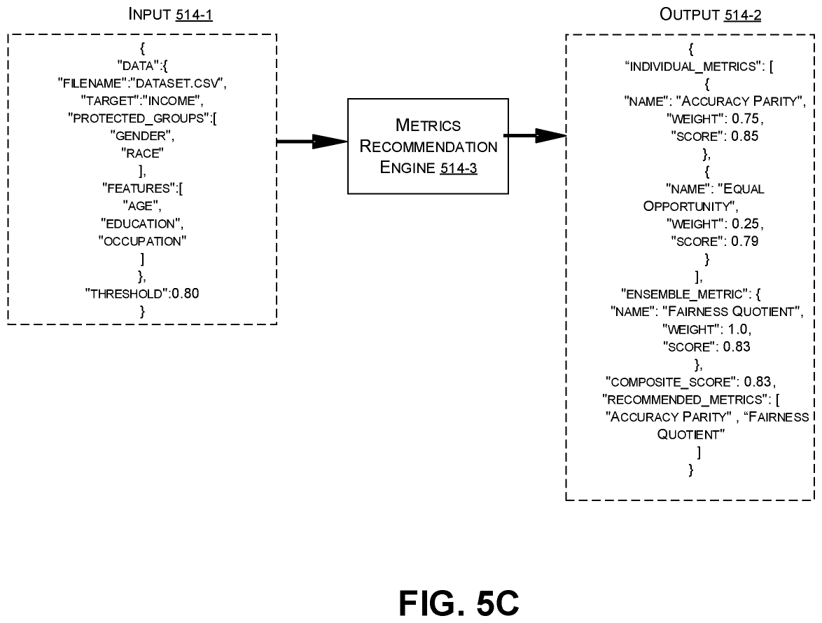

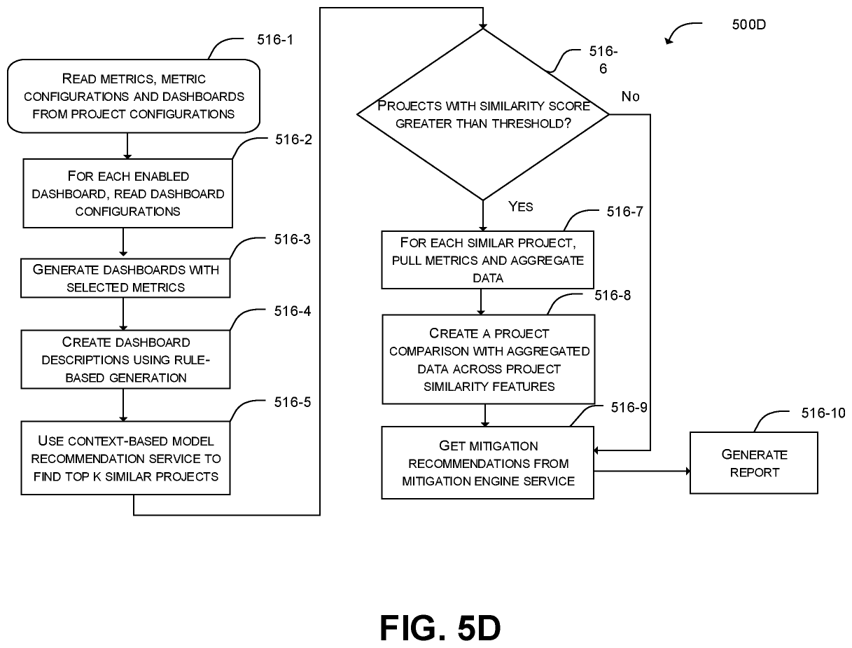

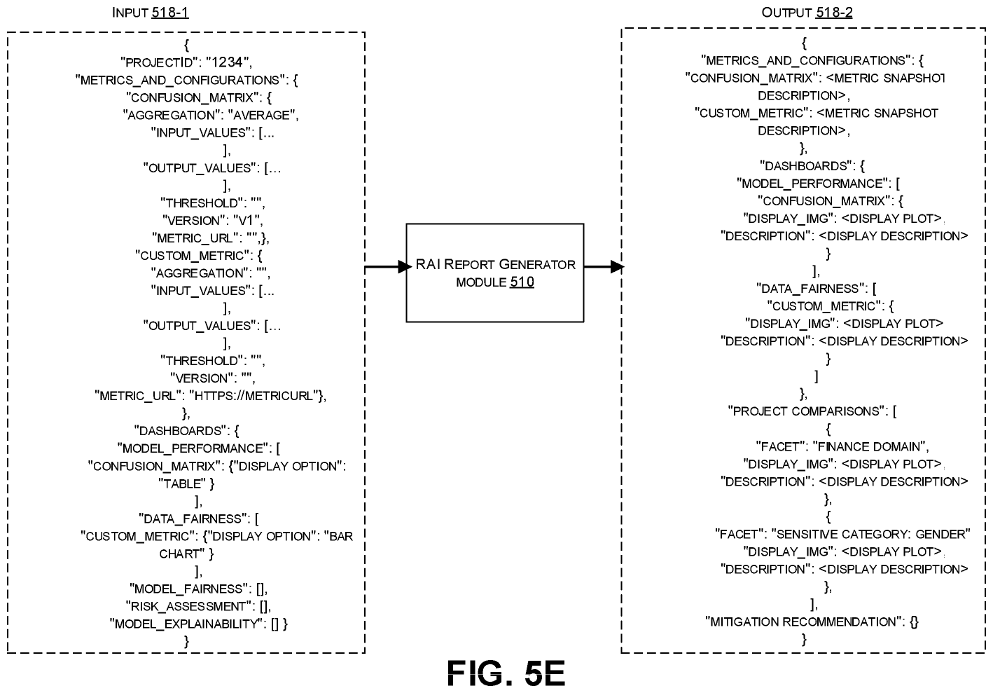

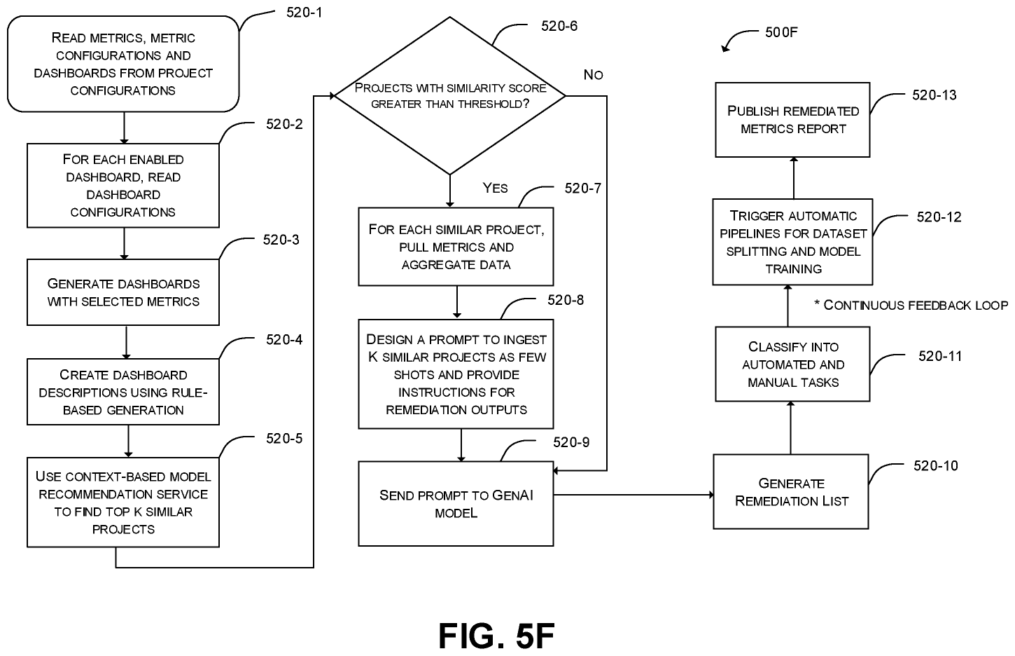

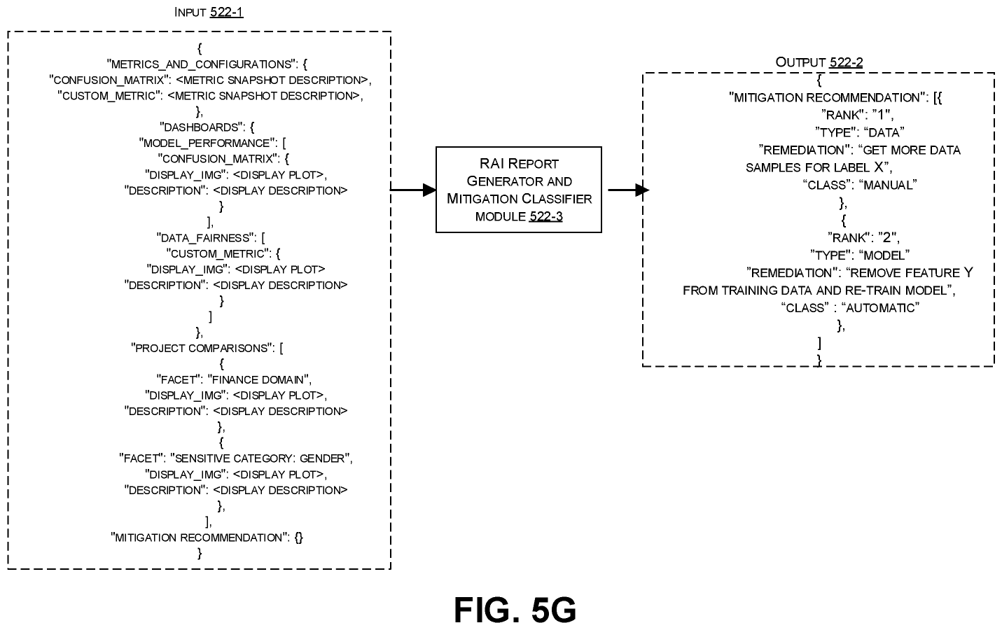

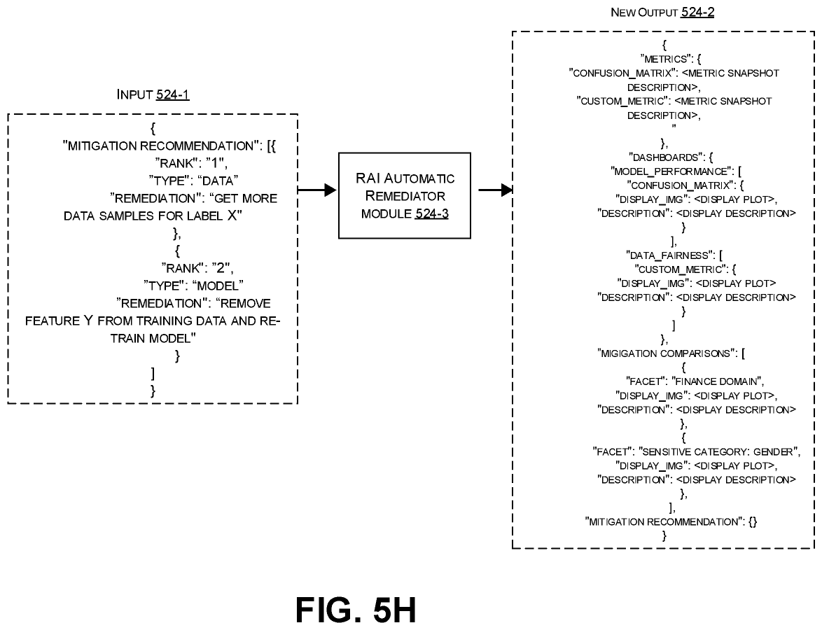

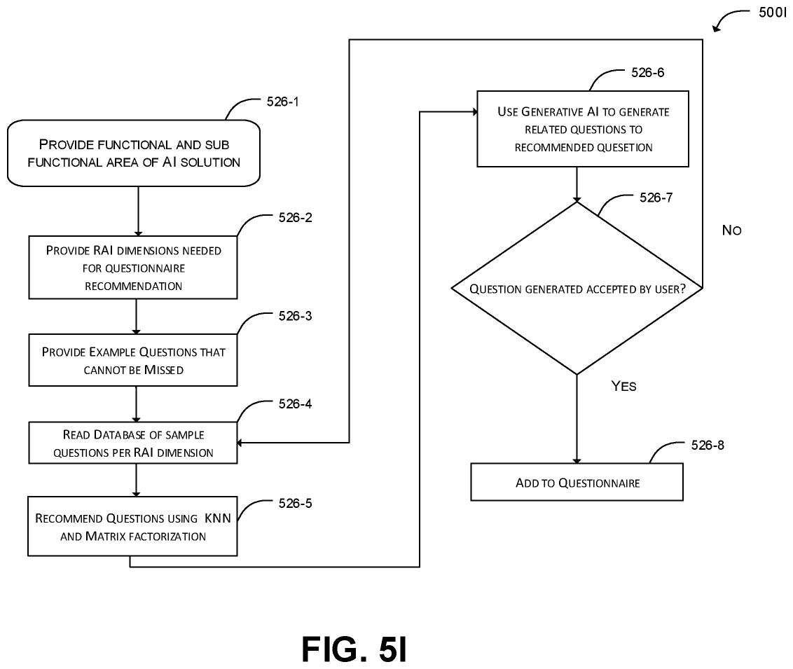

Furthermore, the AI based metrics for generative AI module 320 may assign weights to the determined domain specific fairness metrics based on results of the evaluation. The domain fairness metrics may include finance metrics, human resource metrics and the like. The finance metrics may include class imbalance, accuracy, total variation distance. The human resource metric may include treatment equality, difference in acceptance rates and the like. Additionally, the AI based metrics for generative AI module 320 may compute a composite score for the determined domain-specific fairness metrics by correlating the assigned weights with corresponding domain specific fairness metric. Further, the AI based metrics for generative AI module 320 may map each of the computed composite score with a predefined threshold value and perform bootstrap resampling to assess robustness of the determined domain-specific fairness metrics based on results of mapping. Furthermore, the AI based metrics for generative AI module 320 may compute fairness metrics and composite score for each bootstrap sample. Further, AI based metrics for generative AI module 320 may map a mean value of the computed composite score with the predefined threshold value. Additionally, the AI based metrics for generative AI module 320 may compute an ensemble metric score for each of the bootstrap sample based on results of the mapping. Further, the AI based metrics for generative AI module 320 may generate the ranked list of recommended metrics for the enterprise product based on the computed ensemble metric score. An example of the generated list of recommended metrics is depicted in FIG. 5C.

In an example embodiment, the system 102 may execute the reporting tool integration module 322 to generate a data fairness dashboard 326, a model fairness dashboard 328, a model performance dashboard 330, and a model explainability dashboard 332. Upon creating the assessment project, reporting tool integration module 322 may run the assessment project and create dashboards reporting the RAI metrics and their threshold compliance. In an example embodiment, the reporting tool integration module 322 may generate a report for the enterprise product based on the generated ranked list of recommended metrics. The report includes, but are not limited to, the recommended metrics, dashboard configurations, project comparisons, mitigation options, and the like. For example, the report includes the recommended metrics such as project enabled metrics, snapshots of metric configurations, input parameters. Further, the report may include metrics from the library 308 and user-added metrics. Additionally, the report may include the dashboard configurations such as, but is not limited to, graph representations, descriptions of metric results, and the like. The possible dashboard sections may include, but are not limited to, risk assessment, data fairness, model performance, model fairness, model explainability, and the like. Furthermore, the report may include project comparisons such as, but is not limited to, metric comparisons between project and aggregation of other similar projects on platform, comparisons faceted across similarity features, and the like. The similarity features may include, but is not limited to, data size, domain, detrimental, sensitive data categories, and the like. Furthermore, the report may include mitigation recommendation such as, but is not limited to, options for mitigation of identified risk, data accuracy level based on metric assessments, and the like.

Further, the reporting tool integration module renders a printable report which may include dashboards, metrics, and comparative analyses to other platform projects based on project features. Specifically, the reporting tool integration module runs an algorithm to automatically compare metrics with those of similar projects, and generate a report with printed metrics and remediation suggestions based on past similar remediations.

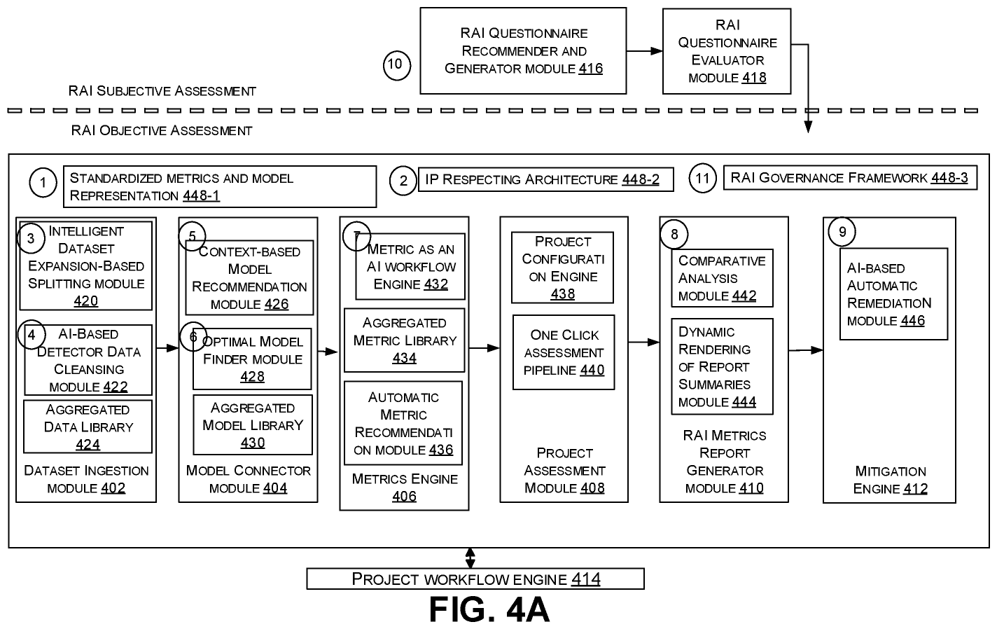

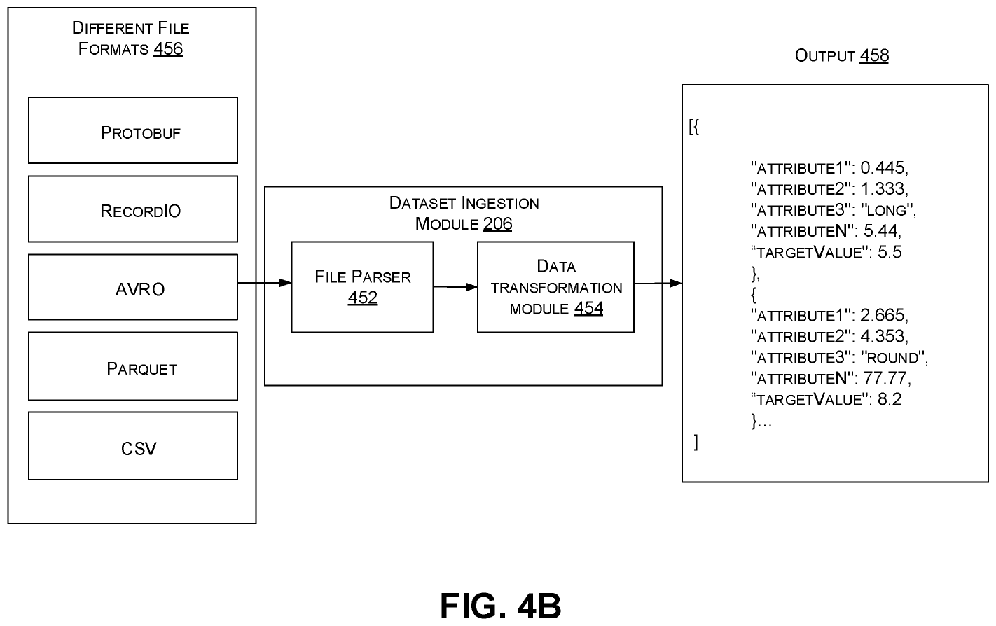

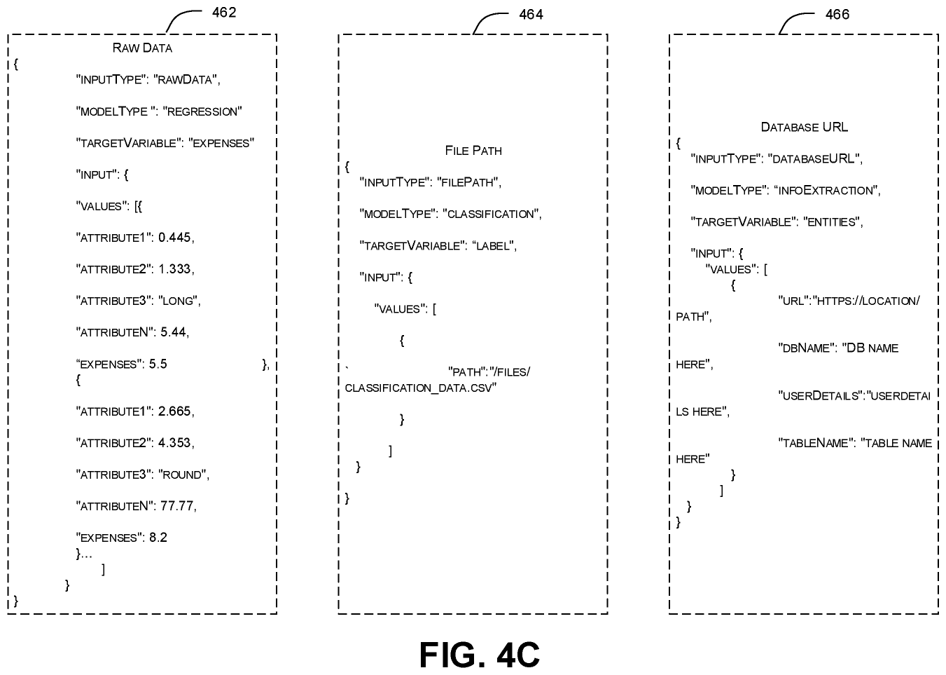

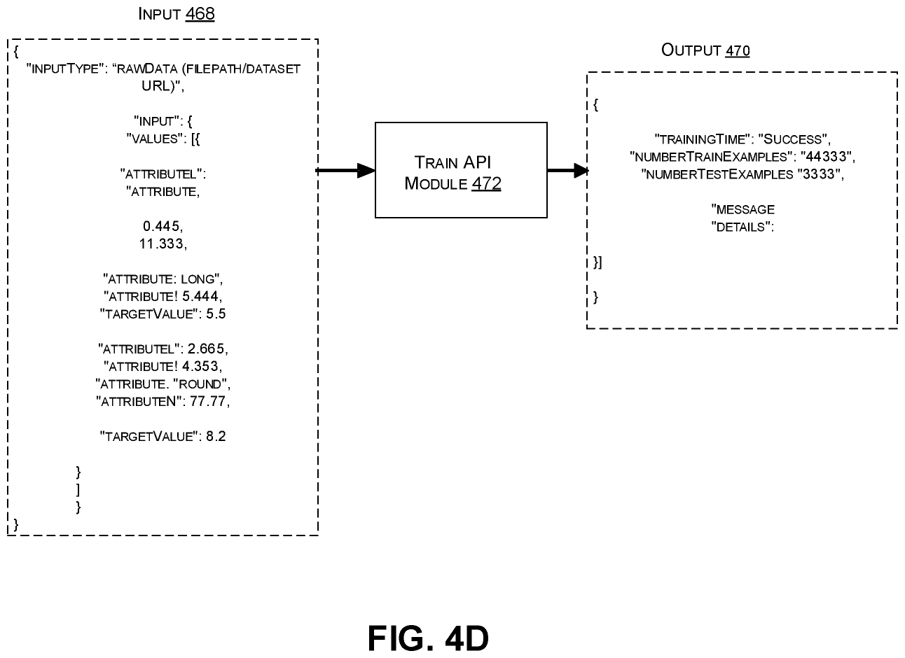

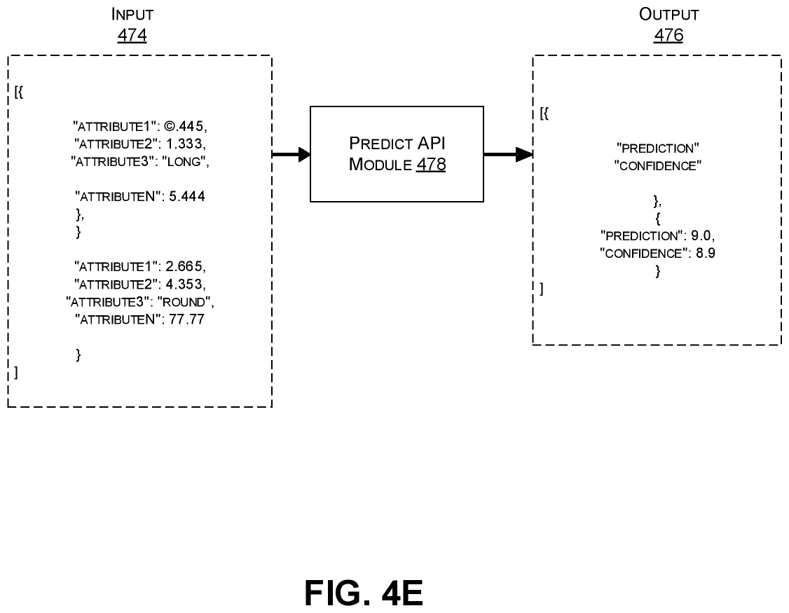

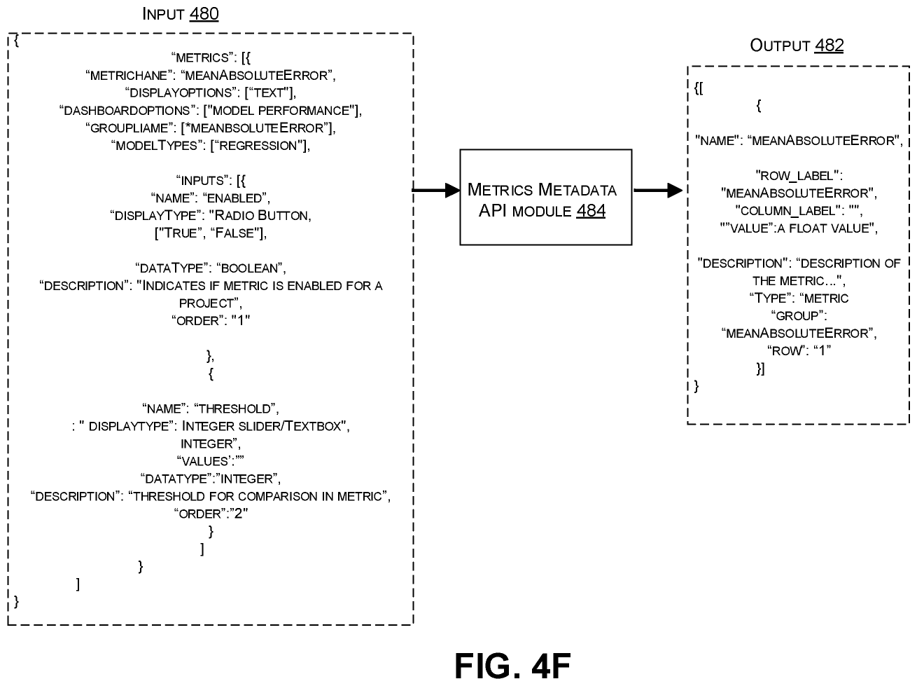

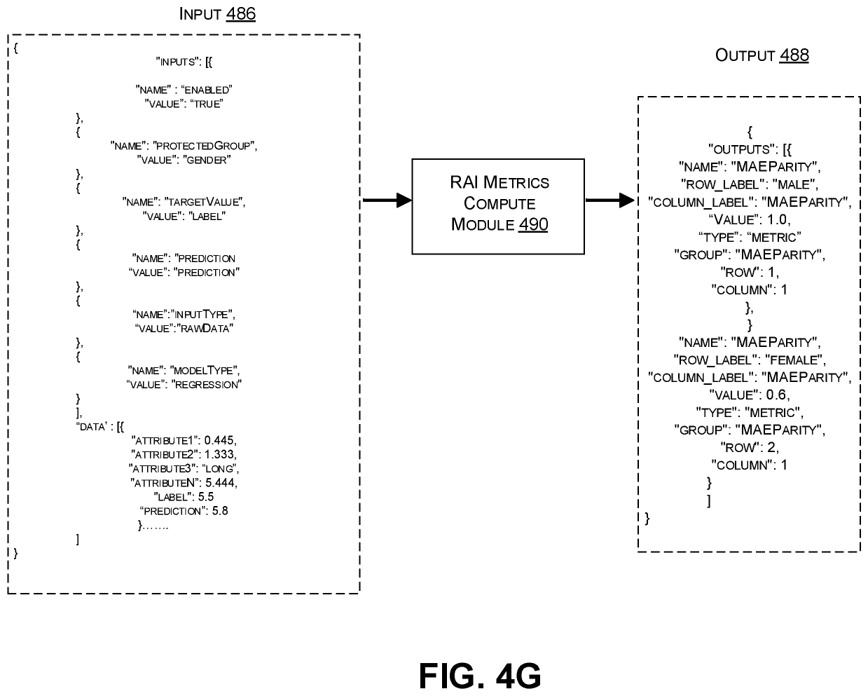

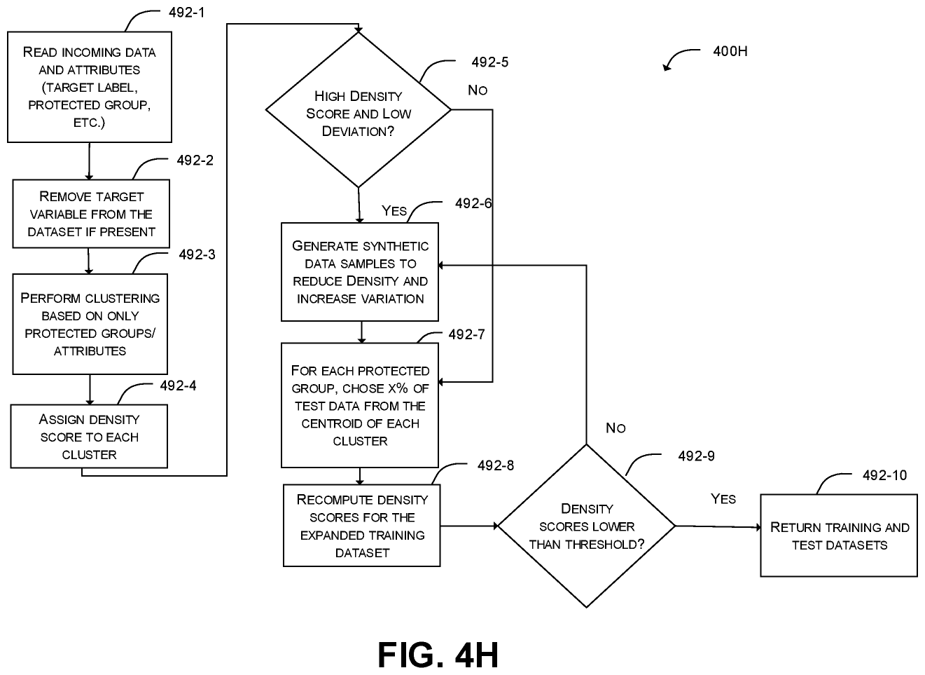

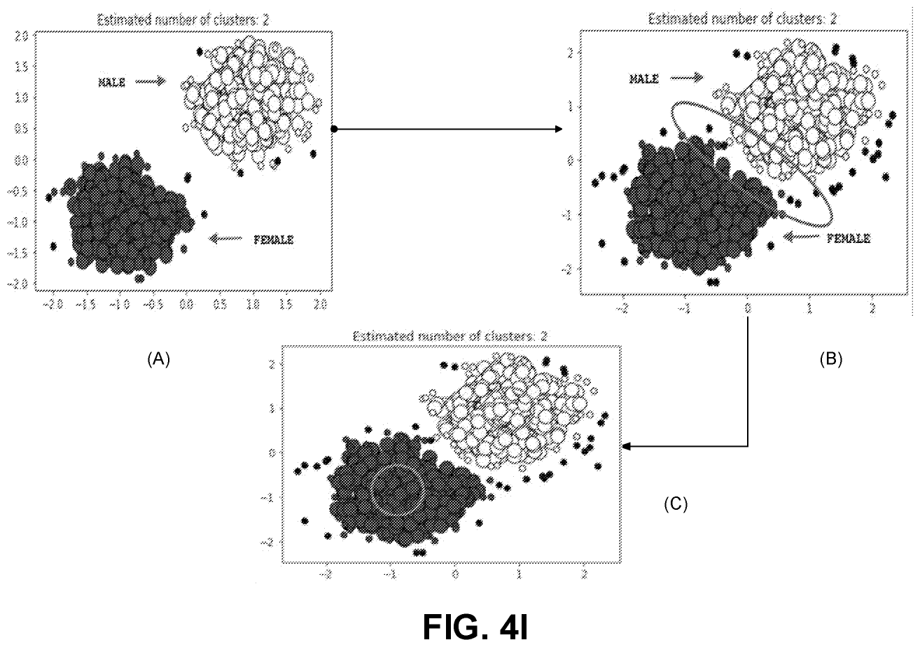

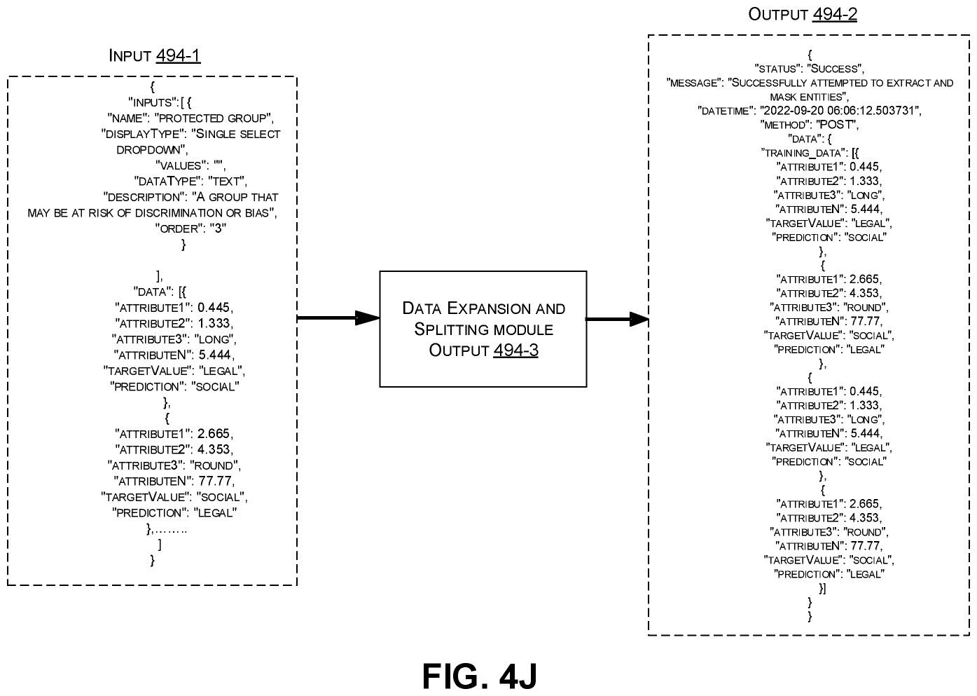

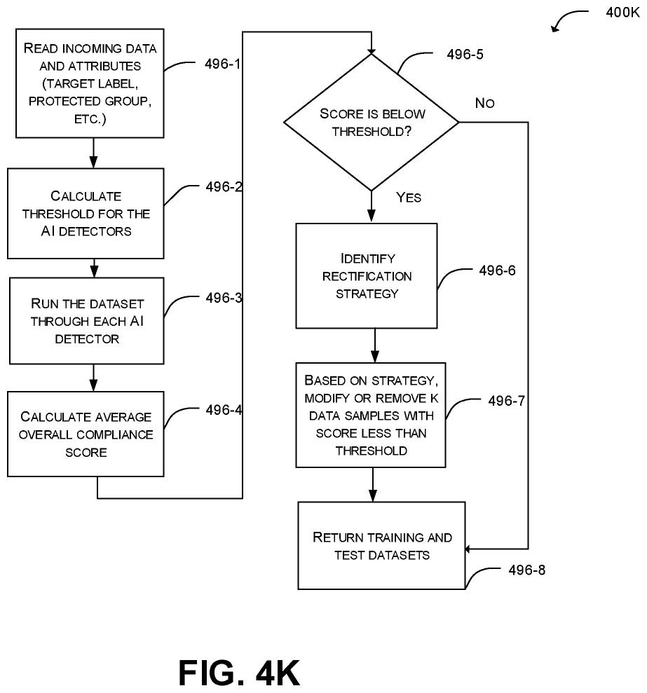

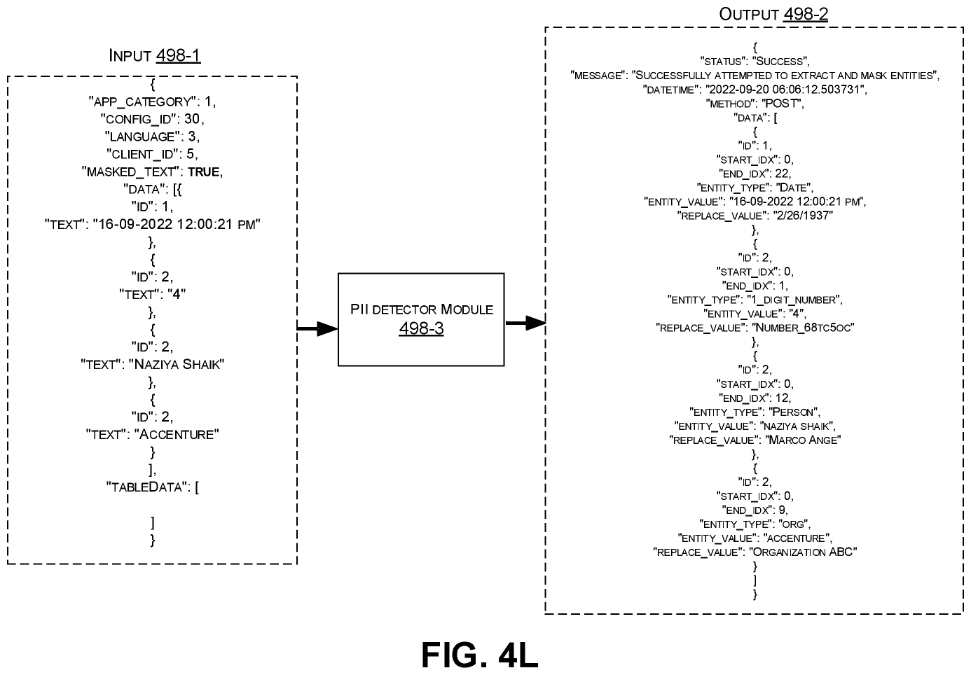

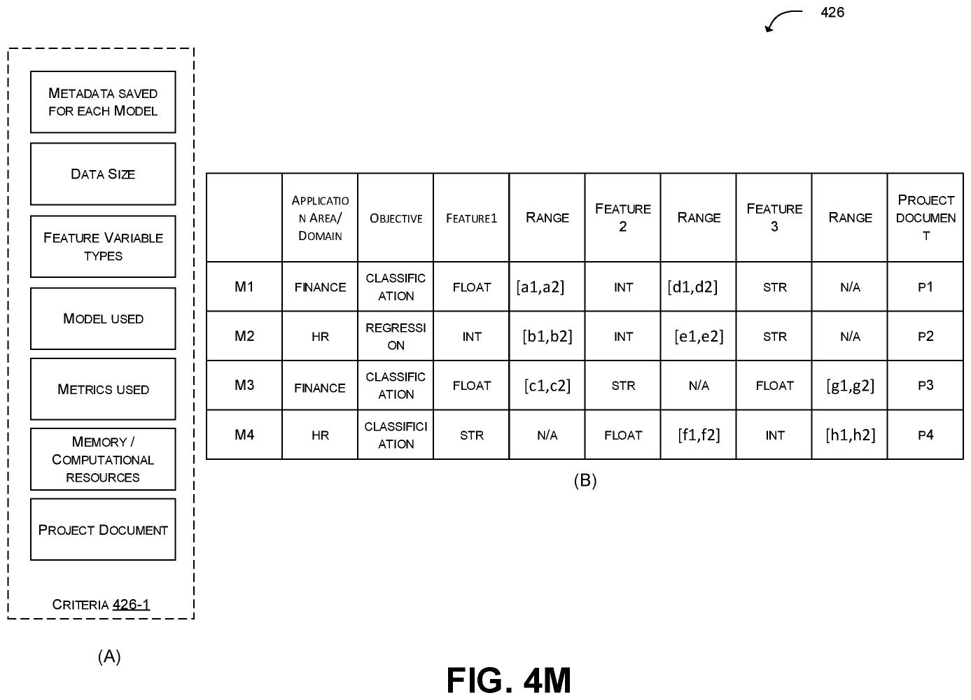

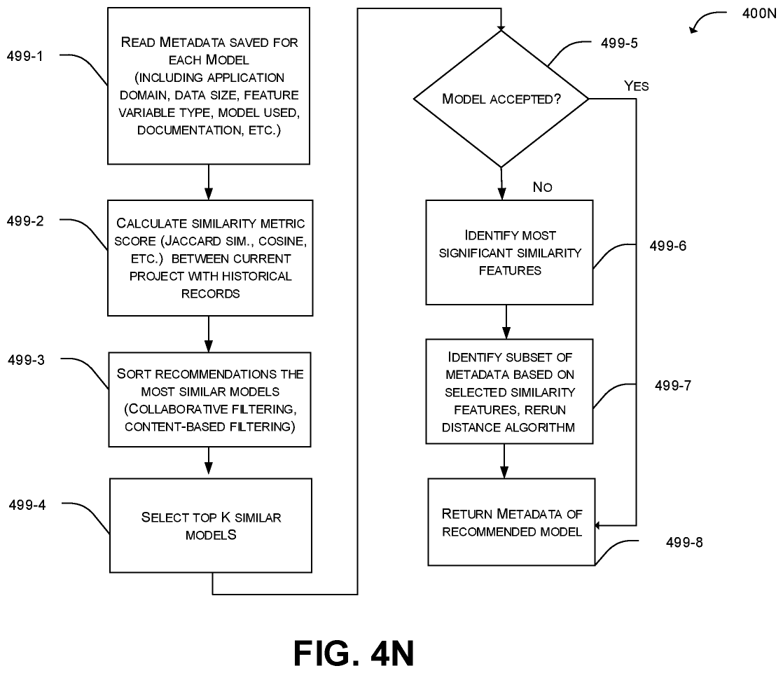

FIG. 4A illustrates an example block diagram representation 400 of the system 102, such as those shown in FIG. 1, capable of monitoring compliance and governance, in accordance with embodiments of the present disclosure. The components of the system 102 are divided into RAI subjective assessment and RAI objective assessment categories. In the RAI objective assessment category, the system 102 may include a dataset ingestion module 402, a model connector module 404, a metrics engine 406, a project assessment module 408, a RAI metrics report generator module 410, and a mitigation engine 412. The system 102 is further connected to a project workflow engine 414. The use cases such as, but are not limited to, cleaning training data, model fairness evaluation, prompt evaluation, full assessment pipeline, automatic model search, model comparison, and optimal model for data ensemble are implemented over the system 102 components. Each of the aforementioned modules contribute to AI continuous learning feedback loop. In the RAI subjective assessment category, the system 102 may include a RAI questionnaire recommender and generator module 416, and a RAI questionnaire evaluator module 418.

In an example embodiment, the dataset ingestion module 206 may include an intelligent dataset expansion-based splitting module 420, an AI based detector data cleansing module 422, and an aggregated data library 424. The dataset ingestion module 402 (such as the dataset ingestion module 206) may further include a standardized metrics and model representation 448-1 for standardizing metrics and AI model representation received from a plurality of data sources. The dataset ingestion module 402 may standardize the representation of different types of metrics and the AI models 302 in for example, Json format, or any other known format. Further, the dataset ingestion module 402 may standardize the predict function and train functions or application programming interfaces (APIs) for a plurality of the AI models 302. The dataset ingestion module 402 may standardize cloud vendors representations, data representation, and metadata representation for a plurality of types of data connections to cloud vendors. Specifically, the dataset ingestion module 402 standardizes many variations and representation of the metrics, the AI models 302, training and predict APIs within the application and across cloud vendors. A detailed view of the dataset ingestion module 402 is depicted in FIG. 4B.

In an example embodiment, the system 102 further includes an intellectual property (IP) respecting architecture 448-2 that allows for the training and testing of the AI models 302 without exposing proprietary information about the AI models 302. The use of containers to expose the AI models 302 as endpoints (e.g., APIs) that can be deployed on a third-party site such that the system 102 does not have access directly to intellectual property, and only functionality.

Further, the intelligent dataset expansion-based splitting module 420 may expand the training datasets using density-based clustering scores with variety of characteristics to enable data accuracy training. The intelligent dataset expansion-based splitting module 420 may reduce inaccurate data on different types of the AI models 302 such as large language models (LLMs) using a unique combination of techniques. The intelligent dataset expansion-based splitting module 420 may provide a cleaner and well-balanced training and the test datasets in terms of protected data attributes present. This is achieved by enabling dataset expansion to increase overall standard deviation. After dataset expansion, the objective of the intelligent dataset expansion-based splitting module 420 is to select a well classified training and test dataset (or may be a subset of training and test dataset) to reduce potential attribute-based inaccuracy in the dataset (for example, profanity, sexual content, racism or any other inaccuracy). The intelligent dataset expansion-based splitting module 420 may receive a plurality of datasets associated with an application or enterprise project which is used to train and predict a given AI model. Further, a list of existing attributes and protected groups within the data are fed to the intelligent dataset expansion-based splitting module 420 as an input. The intelligent dataset expansion-based splitting module 420 may generate an expanded training dataset (and a well-balanced training dataset) and a well-classified test (or subset of test) dataset. The intelligent dataset expansion-based splitting module 420 may use the AI model such as, for example, but not limited to, a density-based spatial clustering of applications with noise (DBSCAN) clustering model, and the like. Alternatively, the intelligent dataset expansion-based splitting module 420 may use any other AI models known in the art in order to carry out the steps described above. A detailed steps involved in the intelligent dataset expansion-based splitting module 420 is depicted in FIG. 4J.

In an example embodiment, the AI-based detector data cleansing module 422 may use AI detectors to identify the potential risks in the training data mask or moderate such content. Specifically, the standardization metrics and model representation 448-1 may allow the metrics to have large complexity and be the AI models 302 themselves (for example, an AI model to quantify inaccuracy on a given model). The AI-based detector data cleansing module 422 may provide a cleaner dataset free from potential risks in training large models. The large models may learn inherent negative characteristics of a data which it was not intended on being trained on. There are certain aspects of datasets that may be detrimental to building a responsible AI (RAI) model such as profanity, racism, classism, and others. Identifying these aspects and building the AI based detectors to filter out the dataset is critical. The AI-based detector data cleansing module 422 may be fed with the plurality of datasets associated with a specific application or a project that is used to train. Further, the AI-based detector data cleansing module 422 may be fed with a list of AI detectors to be factored based on use case. The AI-based detector data cleansing module 422 may then output a clean training dataset free from potential harmful training content. The AI based detector data cleansing module 422 may use information extraction models, and classification models. Alternatively, the AI based detector data cleansing module 422 may use any other AI models known in the art in order to carry out the steps described above. A detailed steps of the AI based detector data cleansing module 422 is shown in FIG. 4K.

In an example embodiment, the model connectors module 404 may include a context-based model recommendation module 426, an optimal model finder module 428, and an aggregated model library 430. The context-based model recommendation module 426 may provide further possibility to explore more models. The context-based model recommendation module 426 may run an AI algorithm to identify similarities between the AI models 302 from different functional areas to recommend optimal AI model for an existing application. A detailed steps involved in a context-based model recommendation module 426 is shown in FIG. 4M

In an example embodiment, the optimal model finder module 428 may use an algorithm to identify optimal model using deterministic time and compute. The optimal model finder module 428 may uses same data set and different input parameters. A detailed steps in context of the optimal model finder module 428 is shown in FIG. 5A

Further, the aggregated model library 430 may be communicatively connected to the AI models 302 as shown in FIG. 3, to fetch the AI models. The aggregated model library 430 may stores the AI models 320, optimal AI models, trained and re-trained AI models, and AI models for various components of the system 102.

In an example embodiment, the metrics engine 408 may be similar to the AI-based metrics for generative AI module 320 shown in FIG. 3. The metrics engine 408 may include metric as an AI workflow engine 432. The metrics engine 408 may recommend appropriate fairness metrics for a given use case based on a project dataset and a model metadata, to ensure that the AI models 302 is accurate and fair. The metrics engine 408 may use an AI model to recommend evaluation metrics for a particular functional application or the AI products 304 based on examples of previously evaluated applications or the AI products 304. The metrics engine 408 may include a plurality of metrics as an AI workflow engine 432, an aggregate metrics library 434, and an automatic metric recommendation module 436. The aggregated metrics library 434 stores the plurality of metrics. A detailed view of steps involved in context of the automatic metric recommendation module 436 is shown in FIG. 5C

The project assessment module 408 may include a project configuration (PC) engine 438 and an one click assessment pipeline 440. The PC engine 438 enables new projects to be setup and configured for the assessment pipeline by providing configuration details on dataset, model, metrics and dashboards to be selected.

In an example embodiment, the RAI metrics report generator module 410 may render a printable report which may include dashboard configurations, metrics, and comparative analysis to other platform projects based on project features. The RAI metrics report generator module 410 may use an algorithm to automatically compare metrics with those of similar projects, and generate a report with printed metrics and remediation suggestions based on past similar remediations. The RAI metrics report generator module 410 may include a comparative analysis module 442 and a dynamic rendering of report summaries module 444. A detailed view of steps involved in context the RAI metrics report generator module 410 is shown in FIG. 5G.

In an example embodiment, the mitigation engine 412 may include an AI based automatic remediation module 446. The AI based automatic remediation module 446 may recommend possible remediation and mitigation strategies based on using one or more shot learning and generative AI algorithms. The AI based automatic remediation module 446 may use an AI model to analyze present level of compliance of an AI solution under development and suggest remediation and mitigation techniques. A detailed view of the steps involved in the context of AI based automatic remediation module 446 is shown in FIG. 5H.

In an example embodiment, the RAI questionnaire recommender and generator module 416 may recommend questionnaires for subjective evaluation of the one or more dimensions (e.g., eight dimensions) of RAI based on functional area and sub-area of application using generative AI and recommendation engine (not shown). Specifically, the RAI questionnaire recommender and generator module 416 may use an AI algorithm to recommend relevant questions to evaluate AI applications based on functional area. The subjective metrics in the one or more dimensions of responsible AI (e.g., soundness, fairness, transparency, accountability, robustness, privacy, sustainability, liability) are normally evaluated using questionnaires. The questionnaires are normally combined together by subject matter experts in RAI. The questions depend on the functional area of the AI solution. The RAI questionnaire recommender and generator module 416 may automatically recommend questionnaires depending on the application area of the AI solution leveraging generative AI and a database of existing questions per dimensional area to evaluate new AI solutions. The RAI questionnaire recommender and generator module 416 may receive the functional area for AI solution and database of previous questions to evaluate AI solutions as an input. Further, the RAI questionnaire recommender and generator module 416 may output a graded recommended questionnaire for new target AI solution. A detailed view of the steps involved in the context of the RAI questionnaire recommender and generator module 416 is shown in FIG. 5I.

In an example embodiment, the RAI governance framework 448-3 within organizations allows any company or organizations in general to monitor an AI application performance over the eight responsible AI dimensions before the release. The RAI governance framework 448-3 may provide automated reports on the dimensions selected and notifies the company compliance tool of compliance status, and risks associated with releasing the tool associated with different levels of compliance. The RAI governance framework 448-3 may use an AI algorithm to evaluate the compliance of AI solutions under development and analyze the risk associated with the release at different levels of threshold compliance over the RAI metrics defined.

FIG. 4B depicts a block diagram of a dataset ingestion module 206, such as those shown in FIG. 3 and FIG. 4A, in accordance with embodiments of the present disclosure. The dataset ingestion module 206 may include a file parser 452 and a data transformation module 454. The dataset ingestion module 206 may create a standard API design for various connectors including a data ingestion, a model ingestion and a metrics creation to ensure platform agnostic behavior and reusability. The dataset ingestion module 206 may receive one or more different file formats 456 as inputs and generates an output 458 such as prediction values, confidence values or metrics values. The prediction values may be for example, but not limited to, for age prediction may include 60, 80, and the like. The confidence values may be for example, but not limited to, 0.9 and the metric values may be for example, but not limited to, accuracy −0.85. The one or more different files may include, but are not limited to, a data file, a target attributes file, a protected groups file, a model path file, a model predictions file, and any other files. The one or more different file formats 456 may include, such as, but not limited to, protobuf, recordio, row-oriented remote procedure call and data serialization framework (e.g., AVRO™), parquet, comma separated value (CSV), and the like. The file parser 452 may parse the one or more different files received as an input and extract respective metadata and attributes. In an example embodiment, the attributes are as shown in FIG. 4B. The data transformation module 454 may transform the one or more different file formats into a generic or a standard file format based on the extracted respective metadata and the attributes. Although, only some examples of the specific input file format are depicted, it may be understood by a person skilled in the art that the description above may be applicable for any other known file format.

FIG. 4C depicts an example API design created by the dataset ingestion module 206 for a plurality of types of file formats, in accordance with embodiments of the present disclosure. The plurality of types of file formats may include a raw data 462, a file path 464, and a database URL 466. The raw data type includes, but is not limited to, an input type, a model type, a target variable and one or more values. The input type may include, but is not limited to, “raw data”, the model type may be “regression”, the target variable may be “expenses” and the one or more values may be one or more attributes. Similarly, the file path type includes, but is not limited to, an input type, a model type, a target variable, one or more values, and the like. The input type may include, but is not limited to, “file path”, the model type may be “classification”, the target variable may be “label”, the one or more values may be one or more attributes including a file path address, and the like. Similarly, the database URL type includes, but is not limited to, an input type, a model type, a target variable, one or more values, and the like. The input type may include, but is not limited to, “database URL”, the model type may be “info extraction”, the target variable may be “entities”, the one or more values may be one or more attributes including a database URL, a database name, user details, a table name, and the like.

Although, in FIG. 4C only some types of file formats are depicted, it may be understood by a person skilled in the art that the API design may be created for any other type of file formats known in the art. In order to create the API design, the dataset ingestion module 206 may consider an input type, a model type, a target variable and one or more values associated with each type of the file formats and then create an API design for that type of file format based on the respective input type, the model type, the target variable and the one or more values. Although, only some examples of the specific input file format are depicted, it may be understood by a person skilled in the art that the description above may be applicable for any other known file format including any API design, any input type, any model type, any target variable and any one or more values.

FIG. 4D depicts a block diagram illustrating an example process of training an API for a given input by the dataset ingestion module 206, in accordance with embodiments of the present disclosure. The dataset ingestion module 206 may include a train API module 472. The train API module 472 may receive an input type and the one or more values for a specific input file format as an input 468. The train API module 472 may further generate an output 470 comprising a training time, number train examples, number test examples, status and errors detected for the specific input file format based on the received input type and the one or more values. The status may be for example, but not limited to, 200 (completed successfully), 400 (errors) and the errors may be for example, but not limited to, 402-Model URL not accessible, Model training timeout and the like. The training time may include, a “success” value, the status may include a “success message” and the errors detected may include a message, details of the error detected, and the like. Further, the input type may include “raw data (file path/dataset URL). The one or more values may include one or more attributes and a target value. Even though a few examples of the specific input file format are depicted, it may be understood by a person of ordinary skill in the art that the description above may be applicable for any other known file format including any input type, any values, any training time, any number train examples, any number test examples, any status and any errors detected, without departing from the scope of the disclosure.

FIG. 4E depicts a block diagram illustrating an example process of predicting an API for a given input by the dataset ingestion module 206, in accordance with embodiments of the present disclosure. The dataset ingestion module 206 may include a predict API module 478. The predict API module 478 may receive an input 474 comprising a plurality of values comprising one or more attributes of a specific input file format. Further, and the predict API module 478 may generate an output 476 such as a prediction score and a confidence score for each of the received plurality of values. The prediction score and the confidence score may be generated by running the model predict function to receive prediction and associated probability scores. Even though a few examples of the specific input file format are depicted, it may be understood by a person of ordinary skill in the art that the description above may be applicable for any other known file format including other plurality of values, other prediction score and other confidence score, without departing from the scope of the disclosure.

FIG. 4F depicts a block diagram illustrating an example process of generating metrics metadata API for a given input by the dataset ingestion module 206, in accordance with embodiments of the present disclosure. The dataset ingestion module 206 may include a metrics metadata API module 484. The metrics metadata API module 484 receives an input 480 comprising plurality of metrics and a plurality of values associated with a specific input file format. Further, the metrics metadata API module 484 may generate an output 482 comprising a metrics metadata API for the received plurality of metrics. In an example embodiment, the plurality of metrics may include, but not limited to, metrics name, display options, dashboard options, group name, model types, and the like. For example, the metrics name may include “means absolute error”, the display option may include “text”. The dashboard options may include “model performance”, and the group name may include “means absolute error”, and the model types may include “regression”. Further, the plurality of values may include a name, a display type, values, a data type, a description, and an order. In an example embodiment, the name may include “threshold”, the display type may include “integer slider/text box”, the data type may include “integer”, the description may include “threshold for comparison in metric” and the order may include “2”.

The metrics metadata API module 484 may include name, row label, column label, values, description, type, group, row value and a column value. In an example embodiment, the name may include “mean absolute error”, the row label may include “mean absolute error”, the value may include “float value”, the description may include “description of the metric”, the type may include “metric”, the group may include “mean absolute error”, the row value may include “1” and the column value may include “1”. Even though a few examples of the specific input file format are depicted, it may be understood by a person of ordinary skill in the art that the description above may be applicable for any other known file format including any other plurality of metrics, other plurality of values and other metrics metadata API, without departing from the scope of the disclosure.

FIG. 4G depicts a block diagram illustrating an example process of computing RAI metrics for a given input by the dataset ingestion module 206, in accordance with embodiments of the present disclosure. The dataset ingestion module 206 may include a RAI metrics compute module 490. The RAI metrics compute module 490 may receive an input 486 comprising one or more input values, and a data. The RAI metrics compute module may then compute a plurality of RAI metrics, referred to as outputs 488 in the FIG. 4G, based on the received one or more input values. The one or more input values may include a name and a value. For example, the name may be “enabled”, “protected group”, “target value”, “prediction”, “input type”, and “model type” and the value may be “true”, “gender”, “label”, “prediction”, “raw data”, and “regression”. The data may be one or more attribute values, a label value and a prediction score. The plurality of RAI metrics may be name, row label, column label, values, description, type, group, row value and a column value. For example, the name may include “mean absolute error (MAE) parity”, the row label may include “male”, the column label may include “MAE parity”, the value may include “1.0”, the type may include “metric”, the group may include “MAE parity”, the row value may include “2” and the column value may include “1”.

In an embodiment, the RAI metrics compute module 490 may run all the metrics with the same design irrespective of the AI model used.

Even though a few examples of the specific input file format are depicted, it may be understood by a person of ordinary skill in the art that the description above may be applicable for any other known file format including any other input values and other RAI metrics, without departing from the scope of the disclosure.

FIG. 4H is a flowchart illustrating an example method 400H of generating the training dataset and the test dataset for the determined plurality of datasets associated with the AI model, in accordance with embodiments of the present disclosure. At step 492-1, the method 400H includes reading, by the processor 110, incoming data and plurality of attributes from the plurality of datasets. The incoming data and the plurality of attributes may include target label, protected group and any other information. At step 492-2, the method 400H includes eliminating, by the processor 110, target variables present in the plurality of datasets which are defined based on application, and model type. At step 492-3, the method 400H includes clustering, by the processor 110, on the plurality of datasets is performed based on the plurality of attributes and the protected groups within the plurality of datasets. At step 492-4, the method 400H includes assigning, by the processor 110, a density score to each cluster of datasets based on a set of parameters. The set of parameters may include estimated number of clusters, homogeneity, completeness, v-measure, adjusted rand index, adjusted mutual information and silhouette coefficient. At step 492-5, the method 400H includes determining, by the processor 110, whether the assigned density score is high and has a low deviation. This is achieved by mapping the assigned density score and a deviation level with a predefined threshold value. If the assigned density score is high and has the low deviation, then at step 492-6, the method 400H includes generating, by the processor 110, synthetic data samples for the cluster of datasets based on the mapped density score and the deviation level. In case the assigned density score is low and has a high deviation, then the loop skips the step 492-6 and jumps to step 492-7. At step 492-7, the method 400H includes selecting, by the processor 110, a “n” percentage of the test dataset from a centroid of each cluster for each of the protected groups. Specifically, for each protected group, an “x” or “n” % of test dataset is chosen from the centroid of each cluster. At step 492-8, the method 400H includes recomputing, by the processor 110, the density scores for expanded training dataset based on the selected n percentage of the test dataset. At step 492-9, the method 400H includes comparing, by the processor 110, the recomputed density scores with the predefined threshold value. If the recomputed density scores are lower than the predefined threshold value, then at step 492-10, the method 400H includes generating, by the processor 110, an expanded training dataset and the classified test dataset upon determining that the recomputed density scores are lower than the predefined threshold value. In case, the recomputed density scores are greater than the predefined threshold value, then the process from step 492-6 are repeated.

FIG. 4I depicts a graphical representation of a density based clustering and synthetic sample generation, in accordance with embodiments of the present disclosure. In FIG. 4I, the graphical representation 4I (A) depicts a process of performing density-based clustering on an original dataset of attributes and calculating metrics based on the set of parameters. The set of parameters may include estimated number of clusters, homogeneity, completeness, v-measure, adjusted rand index, adjusted mutual information and silhouette coefficient. For example, the original dataset of attributes is clustered into “male” cluster and a “female” cluster. Further, the graphical representation 4I (A) depicts selecting data samples that have a spacial distance within the value k from around the centroid of the cluster.

The graphical representation 4I (B) depicts a process of generating samples that fall within a spatial distribution of the clusters to reduce the homogeneity and overall completeness. The view 4I (B) depicts a newly generated samples to reduce cluster distance. The graphical representation 4I (C) depicts a process of reserving points within k distance for the test dataset from each cluster center. This ensures that the overall density score reduces, and the edge samples are used for training.

FIG. 4J depicts a block diagram illustrating an example process of expanding and splitting dataset by the dataset ingestion module 206, in accordance with embodiments of the present disclosure. In an example embodiment, the dataset ingestion module 206 may include an intelligent dataset API specification module 494-3. The intelligent dataset API specification module 494-3 may receive one or more input values, and a data as an input 494-1. The intelligent dataset API specification module 494-3 may then expand and split the datasets based on the received one or more input values and the data. The one or more input values may include a name, a display type, values, a data type, a description and an order. For example, the name may be “protected group”, the display type may be “single select dropdown”, the data types may be “test”, the description may be “a group that may be at risk of inaccuracy” and the order may be “3”. The data may be one or more attribute values, a target value and a prediction score. The intelligent dataset API specification module 494-3 may output 494-2 which includes a status, a message, a date time, a method, a data, and the like. For example, the status may be “success”, the message may be “successfully attempted to extract and mask entities”, and the method may be “post”. Even though a few examples of the input and the output is depicted, it may be understood by a person of ordinary skill in the art that the description above may be applicable for any other known inputs and outputs of intelligent dataset API specification module 494-3, without departing from the scope of the disclosure.

FIG. 4K is a process flowchart illustrating an example method 400K of generating the training dataset and the test dataset for the determined plurality of datasets associated with the AI models 302, in accordance with embodiments of the present disclosure. At step 496-1, the method 400K includes reading, by the processor 110, incoming data and plurality of attributes from the plurality of datasets. The incoming data and the plurality of attributes may include target label, protected group and any other information. At step 496-2, the method 400K includes calculating, by the processor 110, AI detectors to be factored from the determined plurality of datasets, based on the specific application and a compliance threshold value is determined for each of the identified AI detectors. The AI detectors may include profanity detector, PII detector, threat/insult detector and the like.

At step 496-3, the method 400K includes running, by the processor, 110, the determined plurality of datasets through each of the identified AI detector. At step 496-4, the method 400K includes computing, by the processor 110, an average overall compliance score by applying the plurality of datasets to each of the identified AI detectors. At step 496-5, the method 400K includes determining, by the processor 110, whether the average overall compliance score is below the compliance threshold value. In case the average overall compliance score is below the compliance threshold value, then at step 496-6, the method 400K includes identifying, by the processor 110, a compliance rectification strategy by comparing the computed average overall compliance score with the determined compliance threshold value of each of the identified AI detectors. For example, the compliance rectification strategy may be similar to a mitigation strategy. Alternatively, the compliance rectification strategy may be for example, but not limited to, replacing pickle serialization library in training with a more robust serialization library to adhere to security compliance. Further, in case the average overall compliance score is greater than the compliance threshold value, then the steps from step 496-8 is repeated.

At step 496-7, the method 400K includes performing, by the processor 110, one of a modification and an elimination of K data samples upon determining that the computed average overall compliance score is below the compliance threshold value based on the identified rectification strategy. For example, based on the identified rectification strategy, k data samples with the computed average overall compliance score less than the compliance threshold are modified or removed. At step 496-8, the method 400K includes generating, by the processor 110, a filtered training dataset associated with the AI model based on the performed one of the modifications and the elimination.

Table 1 below depicts one or more detrimental factors which are detected using the AI-based detectors. The table1 depicts the detrimental factors, respective category and a description.

TABLE 1

| Factor | Category | Description |
|---|---|---|
| Profanity | Data | Measures profanity |
| Violence | Data | Measures violence |
| Self-Harm | Data | Measures self-harm |
| Sexual | Data | Measures sexual content. |
| Grammar | Data | Identifies if text is written in |
| | | proper grammar. |
| Copyright | Data | Identifies if text is already |
| | | existing in the web. |
| Personal | Data | Detects personal |
| Identifiable Information | | identifiable information and |
| | | removes it from the text. |
| Racism | Data | Measures racist terms. |
| Disinformation | Data | Measures fake news in |
| | | text. |
| Threat | Data | Measures the existence of |
| | | threats |
| Insult | Data | Measures insults |
| Sexism | Data | Measure gender biased |
| | | comments. |
| Languages | Data | Measures different |
| | | languages in prompts and |
| | | filters them. |
| Prompt Size | Data | Measures the prompt size |
| Prompt Interactions | Data | Measures the prompt |
| | | interactions. |

FIG. 4L depicts a block diagram illustrating an example process of generating a filtered training dataset by the dataset ingestion module 206, in accordance with embodiments of the present disclosure. The dataset ingestion module 206 may include a personally identifiable information (PII) detector module 498-3. The PII detector module 498-3 may receive one or more input values and a data as an input 498-1. The one or more input values may include, app category, configuration ID, a language, a client ID, and a masked text. The data may include a plurality of identifiers and text values. The PII detector module may generate the filtered training dataset as output 498-2. The output 498-2 may include a status, a message, a date time, a method and the data. The status may include “success”, the message may include “successfully attempted to extract and mask entities”. Further, the method may include “POST”. The data may include an identifier, a start idx, an end idx, an entity type, an entity value, and a replace value. The entity type may include “date”, “1 digit number”, “person” and “organization”. The replace value is a value with which the entity value needs to be replaced. For example, for identifier 1, the entity value is “16-09-2022 12:00:21 pm” and the replace value is “Feb. 26, 1937”. Even though a few examples of the input values and the output values are depicted, it may be understood by a person of ordinary skill in the art that the description above may be applicable for any other known input values and the output values, without departing from the scope of the disclosure.

FIG. 4M depicts a schematic representation of a context-based model recommendation module 426, such as those shown in FIG. 3 and FIG. 4A, in accordance with embodiments of the present disclosure. The model connectors module 404 may include the context-based model recommendation module 426. The context-based model recommendation module 426 may recommend a best AI model from a set of similar models. The recommendation is generated based on relationships and commonalities between two or more AI models using criteria 426-1 in block (A) of FIG. 4M. The criteria 426 1 may include a metadata saved for each AI model 302, a data size, a model type (such as for example, but not limited to, a classification, a regression and any other model type), a feature type (such as for example, but not limited to float, int, str, or any other feature type), metrics used, memory or computational resources, a context or an application area and a project documentation. The output of the context-based model recommendation module 426 may be a recommended best match AI model. The context-based model recommendation module 426 may use the AI models 302 such as differential evolution (DE), particle swarm optimization (PSO), ant colony optimization (ACO), or any other AI models known in the art for recommending the best match AI model. Alternatively, the context-based model recommendation module 426 may use any other AI models 302 known in the art in order to carry out the steps described above.

The tabular view shown in table (B) of FIG. 4M depicts a mapping of each AI model with the criteria such as application area, objective, features, ranges of features, and project document.

FIG. 4N is a process flowchart illustrating an example method 400N of recommending a best match AI model, in accordance with embodiments of the present disclosure. At step 499-1, the method 400N includes reading, by the processor 110, a metadata saved for each AI model. The metadata may include an application domain, a data size, a feature variable type, a model used, and documentation information. At step 499-2, the method 400N includes calculating, by the processor 110, a similarity metric score between current project (or an enterprise product) and historical records based on the read metadata. At step 499-3, the method 400N includes sorting, by the processor 110, a plurality of recommendations for the AI model based on the computed similarity metric score using a collaborative filtering process and a content-based filtering process. At step 499-4, the method 400N includes selecting, by the processor 110, a top K similar AI models based on the sorted plurality of recommendations. At step 499-5, the method 400N includes determining, by the processor 110, whether the top K similar AI models are accepted. In case the top K similar AI models are accepted, then the loop jumps to step 499-8. In case the top K similar AI models are unaccepted, then at step 499-6, the method 400N includes identifying, by the processor 110, most significant similarity features. At step 499-7, the method 400N includes identifying, by the processor 110, a subset of metadata associated with each of the top K similar AI models based on the selected similarity features and executing a distance algorithm (or technique) for each of the identified subset of metadata. At step 499-8, the method 400N includes generating, by the processor 110, a metadata of recommended AI model.

FIG. 5A is a block diagram of an optimal model finder module 506, such as those shown in FIG. 4A, in accordance with embodiments of the present disclosure. The optimal model finder module 506 may find the best AI model from a set of models 502-1 to 502-N run on same input dataset based on a criterion 504 shown in (I) of FIG. 5A. The criterion 504 may include performance metrics including accuracy, precision, recall, data fairness, model fairness, a dataset size, explainability, a dimensionality, and computational resources consumed using multi objective optimization. The optimal model finder module 506 may receive the plurality of datasets associated with an application project that is used to train. Further, the optimal model finder module 506 also receives the associated data corresponding to each AI model stored on runtime. The optimal model finder module 506 may output an optimized AI model based on the criteria. The optimal model finder module 506 may use AI models such as non-dominated sorting genetic algorithm II (NSGA-II), quantum-inspired evolutionary algorithm (QEA), and glowworm swarm optimization (GSO). Alternatively, the optimal model finder module 506 may use any other AI models known in the art in order to carry out the steps described above.

The optimal model finder module 506 may obtain one or more models stored in the database 104. Further, optimal model finder module 506 may retrieve metadata corresponding to each of the obtained one or more models, and find a pareto optimal front due to conflicting objectives. The pareto optimal front due to conflicting objectives may include, but not limited to, minimum dimensionality, maximum accuracy, and the like. The optimal model finder module 506 then outputs the optimal model M. A graphical representation (II) is shown depicting the pareto optimal front.

FIG. 5B is a process flowchart illustrating an example method 500B of generating a ranked list of recommended metrics for the enterprise product, in accordance with embodiments of the present disclosure. At step 512-1, the method 500B includes, reading, by the processor 110, incoming data and plurality of attributes from the plurality of datasets. The incoming data and the plurality of attributes may include target label, protected group and any other information. At step 512-2, the method 500B includes determining, by the processor 110, domain-specific fairness metrics from a metric library. At step 512-3, the method 500B includes evaluating, by the processor 110, a feasibility value of applying the determined domain specific fairness metrics to the plurality of datasets based on the plurality of attributes and the protected groups within the plurality of datasets. At step 512-4, the method 500B includes assigning, by the processor 110, weights to the determined domain specific fairness metrics based on results of the evaluation. At step 512-5, the method 500B includes calculating, by the processor 110, a composite score for the determined domain-specific fairness metrics by combining the assigned weights with corresponding domain specific fairness metric. At step 512-6, the method 500B includes determining, by the processor 110, whether the composite score is less than a predefined threshold value. In case if the composite score is greater than the predefined threshold value, then loop jumps to the step 512-8. Alternatively, if the composite score is less than the predefined threshold value, then at step 512-7, the method 500B includes assessing, by the processor 110, the next available domain specific fairness metric. At step 512-8, the method 500B includes performing, by the processor 110, bootstrap resampling to assess the robustness of the determined domain-specific fairness metrics. The results of bootstrap resampling generate a bootstrap sample. At step 512-9, the method 500B includes calculating, by the processor 110, the domain-specific fairness metrics and a composite score for each of the bootstrap sample. At step 512-10, it is determined whether the composite score is less than the predefined threshold value. In case if the composite score is less than the predefined threshold value, then the loop jumps back to step 512-7. Alternatively, if the composite score is greater than the predefined threshold value, then at step 512-11, the method 500B includes calculating, by the processor 110, an ensemble metric score for each of the bootstrap sample. At step 512-12, the method 500B includes recommending, by the processor 110, an individual and the ensemble metrics in the order of relevancy.

FIG. 5C is a block diagram of a metrics recommendation engine 514-3, in accordance with embodiments of the present disclosure. The metrics recommendation engine 514-3 is similar to metrics engine 408 as shown in FIG. 4A. The metrics recommendation engine 514-3 recommends appropriate fairness metrics for a given use case based on a project dataset and a model metadata, in order to ensure that the model is accurate and fair. The metrics recommendation engine 514-3 receives the dataset as input 514-1 associated with the application/project which contains attributes such as target label, protected group, and other relevant features. The attributes may be for example, filename such as “dataset.csv”, target label such as “income”, protected groups such as “gender”, “race” and other features such as “age”, “education”, “occupation” and other information. The metrics recommendation engine 514-3 may then output 514-2 a ranked list of recommended individual and ensemble metrics in order of relevancy along with their respective composite scores. The metrics recommendation engine 514-3 may use AI models such as regression, information extraction, and classification models. Alternatively, the metrics recommendation engine 514-3 may use any other AI models known in the art in order to carry out the steps described above.

The individual metrics and the ensemble metrics may be for example, name, weight and composite score value. The recommended metrics may be, for example, accuracy parity, and fairness quotient.

Table 2 below depicts an example metrics library.

TABLE 2

| Metrics | Description | Calculation |
|---|---|---|
| Disparate | Measures the ratio of the | DIR = (P(Y = 1 \| D = 1)/P(Y = |
| Impact | probability of a positive | 1 \| D = 0)) |
| Ratio (DIR) | outcome for a protected | |
| | group to the probability | |
| | of a positive outcome for | |
| | a non-protected group | |
| Equal | Measures the difference | Equal Opportunity = |
| Opportunity | in true positive rates | PR_protected − |
| Difference | (TPR) between a | TPR_non_protected |
| | protected and a non- | |
| | protected group | |
| Statistical | Measures the difference | SPD = P(Y = 1 \| D = 1) − |
| Parity | in the probability of | P(Y = 1 \| D = 0) |
| Difference | positive outcomes | |
| (SPD) | between protected and | |
| | non-protected groups. | |
| Treatment | Measures the difference | TED = P(Y = 1 \| D = 1, A = |
| Equality | in the proportion of | 1) − P(Y = 1 \| D = 0, A = |
| Difference | favorable outcomes | 1) − (P(Y = 1 \| D = 1, A = |
| (TED) | between protected and | 0) − P(Y = 1 \| D = 0, A = 0)) |
| | non-protected groups | |
| False | Measures the rate at | FPR = FP/(FP + TN) |
| Positive | which positive outcomes | |
| Rate (FPR) | are predicted for the | |
| | negative outcomes | |
| False | Measures the rate at | FNR = FN/(TP + FN) |
| Negative | which negative outcomes | |
| Rate (FNR) | are predicted for the | |
| | positive outcomes | |
| Positive | Measures the proportion | PPV = TP/(TP + FP) |
| Predictive | of positive predictions | |
| Value | that are true positive | |
| (PPV) | | |
| Negative | Measures the proportion | NPV = TN/(TN + FN) |
| Predictive | of negative predictions | |
| Value | that are true negative | |
| (NPV) | | |
| Equalized | Measures the difference | EOD = (TPR1 − TPR0) − |
| Odds | in true positive rate and | (FPR1 − FPR0) |
| Difference | false positive rate | |
| (EOD) | between the protected | |
| | and unprotected groups | |
| Accuracy | Measures whether the | Accuracy_Parity = |
| Parity Value | accuracy of the model is | P(C = Y\|A = a) = P(C = |
| | consistent across groups | Y\|A = b) |

Metrics may be added easily by providing them as containers and implementing two standardized functions, such as computeMetric and get metric metadata. The metrics are visualized in the system 102 with no additional work.

FIG. 5D is a process flowchart illustrating an example method 500D of generating an RAI metrics report, according to an embodiment of the present disclosure. At step 516-1, the method 500D may include reading, by the processor 110, metrics, metric configurations and dashboards from project configurations. At step 516-2, the method 500D may include reading, by the processor 110, for each enabled dashboard, the dashboard configurations. At step 516-3, the method 500D may include generating, by the processor 110, dashboards with selected metrics. At step 516-4, the method 500D may include creating, by the processor 110, dashboard descriptions using rule-based generation. At step 516-5, the method 500D may include determining, by the processor 110, top k similar projects by using the context-based model recommendation module. At step 516-6, the method 500D may include determining, by the processor 110, whether the projects with similarity score is greater than a predefined threshold. If the projects with similarity score is lower than the predefined threshold value, then the loop jumps to step 516-9. In case if the projects with similarity score is greater than a predefined threshold, then at step 516-7, the method 500D may include pulling, by the processor 110, metrics d for each similar project and aggregating corresponding data. At step 516-8, the method 500D may include creating, by the processor 110, a project comparison with the aggregated data across project similarity features. At step 516-9, the method 500D may include obtaining, by the processor 110, mitigation recommendations from mitigation engine. The mitigation recommendations may include, for example, but not limited to, documentation, metric definition (Threshold where applicable), metric evaluation (Previously validation), metric improvement, test case(s) definition, data collection, test case(s) evaluation, methodology(s) definition, methodology(s) implementation, methodology(s) testing, model retraining, role assignment/identification, expert consultation, dataset quality validation, data understanding, license verification, code review/scan and the like. At step 516-10, the method 500D may include generating, by the processor 110, a RAI metrics report.

FIG. 5E depicts a RAI metrics report generator module 510, such as those shown in FIG. 4A, in accordance with embodiments of the present disclosure. In an example embodiment, different model types use a wide variety of metrics with varying inputs, outputs, and metric aggregation options. Using a standardized metric representation, the RAI metrics report generator module 510 creates metric reports dynamically without having to implement code changes to accommodate these different options. Moreover, the RAI metrics report generator module 510 may provide cross-platform metric comparisons based on similar project features. The RAI metrics report generator module 510 receives metrics, dashboard configurations, similar models from context-based model recommendation module, and mitigation recommendations from mitigation engine as input 518-1. The RAI metrics report generator module 510 generates an output 518-2 including a standardized report with the metrics, the dashboards, the project comparisons, and the mitigation options. In an embodiment, metrics may include project enabled metrics, snapshots of metric configurations, and input parameters. Further, the metrics may include metrics from metric library and user-added metrics. The dashboards may include graph representations and descriptions of metric results. The possible dashboard sections may include risk assessment, data fairness, model performance, model fairness, and model explainability. The project comparisons may include metric comparisons between project and aggregation of other similar projects on platform, comparisons faceted across similarity features such as for example, a data size, a domain, detrimental and sensitive data categories. The mitigation recommendation may include options for mitigation of identified risk and inaccuracy based on metric assessments. In FIG. 5E, the RAI metrics report generator module 510 is fed with project identifier (ID), metrics and configurations, dashboards, and a table. The project ID may be “1234”, the metrics_and_configurations may be “confusion_matrix” including “aggregation”: “average”, “input_values”, “output_values”, “threshold”, “version”: “v1” and “metric_url”. Further, the metrics_and_configurations may include “custom_metric”, “aggregation”, “input_values”, “output_values”, “threshold”, “version” and “metric_url”: https://metricurl. The dashboards may include “model_performance”, “confusion_matrix”: {“display option”: “table”, “data_fairness”, custom_metric”: {“display option”: “bar chart”, “model_fairness”, “risk_assessment”, and “model_explainability”. The output 518-2 of the RAI metrics report regenerator module 510 includes metrics and configurations, dashboards, data fairness, project comparisons and mitigation options or recommendations.

FIG. 5F is a process flowchart illustrating an example method 500F of determine the mitigation strategy for the enterprise product based on the generated report, in accordance with embodiments of the present disclosure. At step 520-1, the method 500F includes, reading, by the processor 110, metrics, metric configurations and dashboards from project configurations. At step 520-3, the method 500F includes, reading, by the processor 110, dashboard configurations for each enabled dashboard. At step 520-3, the method 500F includes generating, by the processor 110, dashboards with selected metrics. At step 520-4, the method 500F includes creating, by the processor 110, dashboard descriptions for the generated dashboard views using pre-stored rules. At step 520-5, the method 500F includes determining, by the processor 110, a top k similar projects using context-based model recommendation module. A similarity score for each of pre-stored similar enterprise products is generated. The pre-stored similar products are determined using similarity metric between the current enterprise product and pre-stored enterprise products. At step 520-6, it is determined whether projects with similarity score is greater than a predefined threshold. In case if the projects with similarity score is lower than a predefined threshold, then the loop jumps to step 520-9. Alternatively, in case the projects with similarity score are greater than a predefined threshold, then at step 520-7, the method 500F includes pulling, by the processor 110, metrics for each similar project and aggregating the corresponding data. At step 520-8, the method 500F includes designing, by the processor 110, a prompt to ingest K similar projects as few shots and providing instructions for remediation outputs. At step 520-9, the method 500F includes sending, by the processor 110, the prompt to a generative AI model. Specifically, the created dashboard descriptions, and the generated remediation outputs are applied to the generative AI model. At step 520-10, the method 500F includes generating, by the processor 110, a remediation list based on results of the generative AI model. At step 520-11, the method 500F includes classifying, by the processor 110, the generated remediation list into an automated task and a manual task. At step 520-12, the method 500F includes triggering, by the processor 110, automatic pipelines for dataset splitting and model training based on the classified automated task and the manual task. At step 520-13, the method 500F includes generating and publishing, by the processor 110, a remediated metrics report for the enterprise product based on the triggered automatic pipelines and the generated remediation list.

FIG. 5G depicts a block diagram of a RAI report generator and mitigation classifier module 522-3, in accordance with embodiments of the present disclosure. The RAI report generator and mitigation classifier module 522-3 receives metrics and configurations, dashboards, project comparisons and mitigation recommendations as input 522-1. The RAI report generator and mitigation classifier module 522-3 generates an output 522-2 including a mitigation recommendation based on the received metrics and configurations, the dashboards, the project comparisons and the mitigation recommendations.

FIG. 5H depicts a block diagram of a RAI automatic remediator module 524-3, in accordance with embodiments of the present disclosure. The RAI automatic remediator module 524-3 creates remediations recommendations using a few shots learning approach based on the questionnaire responses, and the assessment reports for objective metrics. This is achieved by providing relevant and similar historical examples to generate remediation strategies to mitigate existing inaccuracy and perform relevant actions to automate certain remediation by selection of a new dataset and retrain the optimal model to get better metric results. The RAI automatic remediator module 524-3 receives the questionnaire responses, the historical remediations from similar use cases, a model metadata and a dataset metadata as an input 524-1. The RAI automatic remediator module 524-3 may generate an output 524-2 comprising a list of ranked remediation steps for the project with scores on effort, re-selected dataset and re-trained model. The RAI automatic remediator module 524-3 may use an AI model such as generative AI (GenAI). Alternatively, the RAI automatic remediator module 524-3 may use any other AI models known in the art in order to carry out the steps described above.

FIG. 5I is a process flowchart depicting a method 5001 of evaluating the enterprise product by a RAI questionnaire recommender module 524-3, in accordance with embodiments of the present disclosure. At step 526-1, the method 5001 includes, providing, by the processor 110, a functional and sub-functional area of AI solution or an enterprise product. At step 526-2, the method 5001 includes, providing, by the processor 110, a responsible AI (RAI) dimensions required for recommending the questionnaire, based on the determined functional and sub-functional area of the enterprise product. At step 526-3, the method 5001 includes identifying, by the processor 110, example questions that cannot be missed based on the identified RAI dimensions using an AI questionnaire model. The AI questionnaire model comprises pre-stored questions. At step 526-4, the method 5001 includes reading, by the processor 110, a database of sample questions as per RAI dimension. At step 526-5, the method 5001 includes recommending, by the processor 110, questions using for example, but not limited to, KNN and Matrix factorization AI models. At step 526-6, the method 5001 includes generating, by the processor 110, related questions to recommended questions using a generative AI model. At step 526-7, it is determined whether the related questions generated are accepted by user. If the related questions generated are not accepted by the user, then the loop goes back to step 526-5. If the related questions generated are accepted by the user, then at step 526-8, the method 5001 includes adding, by the processor 110, the related questionnaires to the database.

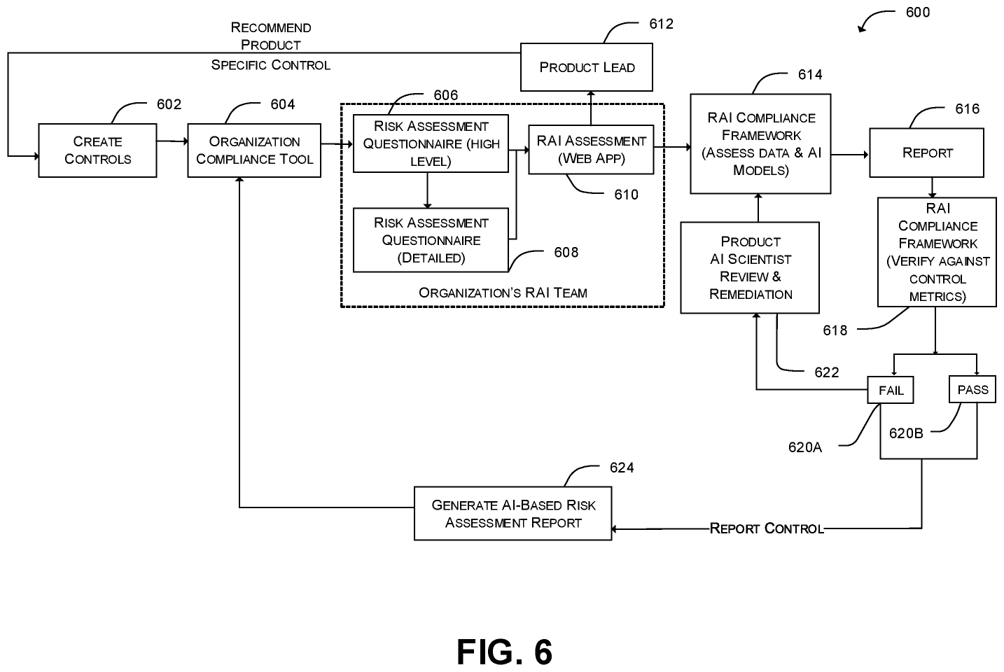

FIG. 6 illustrates an exemplary flow diagram representation of a method 600 for managing a RAI product governance lifecycle in an enterprise, in accordance with embodiments of the present disclosure.

At step 602, the method 600 includes creating, by the processor 110, controls in an organization compliance tool. The organization compliance tool may include, but is not limited to, a continuous data protection (CDP), an information security management system (ISMS), an information security management system (ISMS), a responsible artificial intelligence (RAI) system, and the like.

At step 604, the method 600 includes inputting, by the processor 110, the created controls to the organization compliance tool. At step 606, the method 600 includes displaying, by the processor 110, a risk assessment questionnaire (high level) on a user device 106. At step 608, the method 600 includes displaying, by the processor 110, the risk assessment questionnaire (detailed) on the user device 106. At step 610, the method 600 includes performing, by the processor 110, an RAI assessment (e.g., using web application) on the risk assessment questionnaire (high level) and the risk assessment questionnaire (detailed). At step 612, the method 600 includes receiving, by the processor 110, an input from a product lead to recommend product specific control for creating the controls to the organization compliance tool at step 602. The product lead defines metrics in objective RAI dimensions and the metrics are entered in the organization compliance tool

At step 614, the method 600 includes utilizing, by the processor 110, a RAI compliance framework (also referred herein as the system 102) to assess a data and AI models. At step 616, the method 600 includes generating, by the processor 110, a report based on the assessment. At step 618, the method 600 includes utilizing, by the processor 110, the RAI compliance framework to verify the generated report against control metrics. The RAI compliance framework is used to evaluate the AI models and the data in order to produce the report which is compared against a defined metrics in an iterative process.

If the verification of the control metrics is not verified, then at step 620A, the method 600 includes generating, by the processor 110, a failure notification. Further, if the verification of the control metrics is successfully verified, then at step 620B, the method 600 includes generating, by the processor 110, a pass notification. At step 622, the method 600 includes receiving, by the processor 110, a review and a remediation from a product AI scientist, if the verification of the control metrics is not verified at step 620A. At step 624, the method 600 includes generating, by the processor 110, an AI based risk assessment report, based on results of verification at step 620A and 620B.

In an example embodiment, three controls may have failed and seven controls may have passed the verification. In such a case, the control on model performance may be an overall model accuracy >=65%.

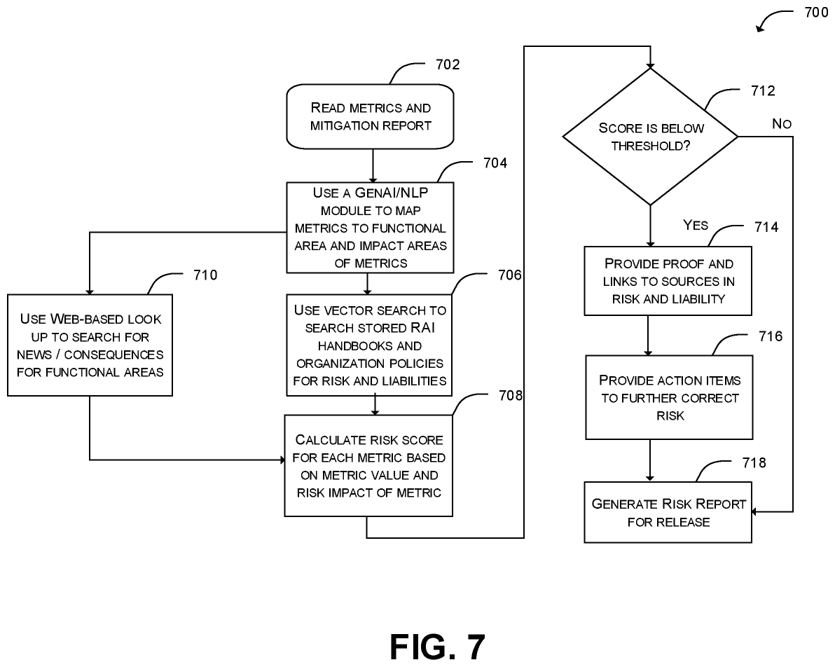

FIG. 7 illustrates an exemplary flow diagram representation of a method 700 for generating AI based risk assessment report, in accordance with an embodiment of the present disclosure.

At step 702, the method 700 includes reading, by the processor 110, metrics and mitigation report associated with the plurality of datasets. At step 704, the method 700 includes utilizing, by the processor 110, a generative artificial intelligence (genAI)/natural language processing (NLP) module to map the metrics to a functional area and impact areas of the metrics. At step 706, the method 700 includes utilizing, by the processor 110, a vector search to search stored RAI handbooks and organization policies for risk and liabilities. At step 708, the method 700 includes calculating, by the processor 110, a risk score for each metric based on a metric value and a risk impact of the metric, by utilizing, at step 710, a web-based look up to search for news or consequences for the functional areas. At step 712, the method 700 includes determining, by the processor 110, if the risk score is below a threshold value. At step 714, the method 700 includes providing, by the processor 110, proof and links to sources in risk and liability if the risk score is below the threshold value. In case if the risk score is above the threshold value, then the loop jumps to step 718. At step 716, the method 700 includes providing, by the processor 110, action items to further correct a risk associated with the metric. At step 718, the method 700 includes generating, by the processor 110, a risk report for release.

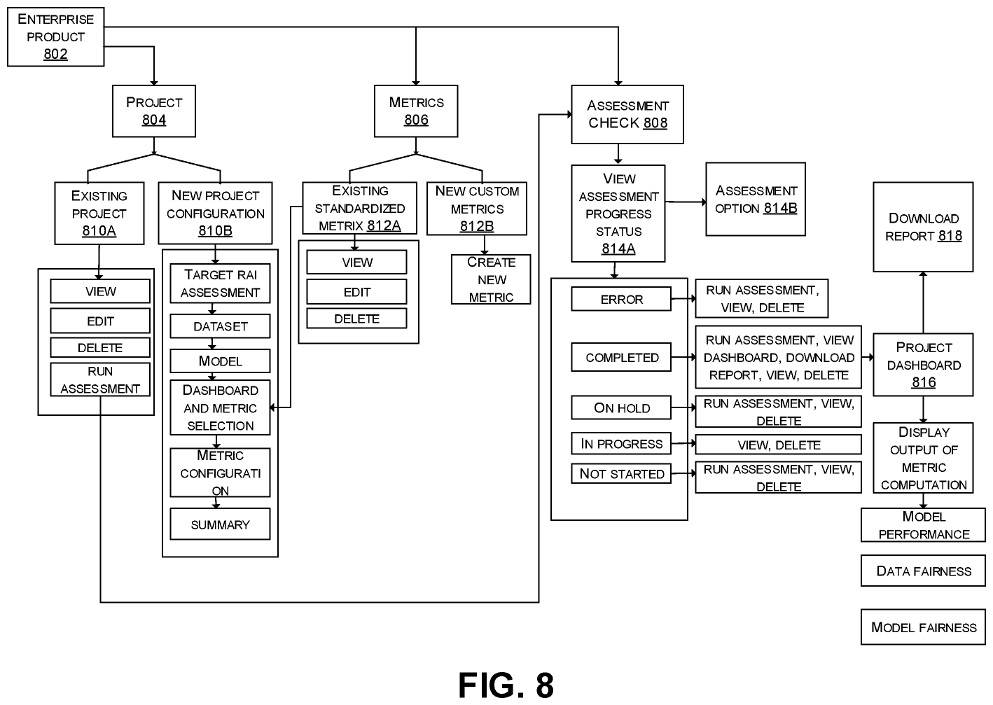

FIG. 8 illustrates an exemplary block diagram representation of functions of a RAI framework 800, in accordance with an embodiment of the present disclosure.

The RAI framework 800 may include an enterprise product 802. The enterprise product 802 may include a project 804, metrics 806, and an assessment check 808.

Further, the project 804 may include an existing project 810A, and a new project configuration 810B. The system 102 may allow a user to view, edit, delete, and run assessment on the existing project 810A. Further, the new project configuration 810B may include a target RAI assessment, a dataset, a model, a dashboard and metric selection, a metric configuration, and a summary.

Furthermore, the metrics 806 may include an existing standardized metrics 812A, and a new custom metrics 812B. The system 102 may allow the user to view edit and delete the existing standardized metrics 812A. The dashboard and metric selection under the new project configuration 810B may be performed using the existing standardized metrics 812A. Further, the system 102 may create new metrics under the new custom metrics 812B.

The assessment check 808 may include a view progress assessment status interface 814A. The system 102 may display the status of assessment progress as at least one of error, completed, on hold, in progress, not started, and the like. The view progress assessment status interface 814A may display assessment option 814B. In case of error status, the system 102 may allow to run assessment, view, and delete the assessment. Further, in case if assessment is completed, then the system 102 may allow to run assessment, view dashboard, download report, view, and delete the assessment. Further, in case of the assessment status is on hold, the system 102 may allow to run assessment, view, and delete the assessment. Furthermore, in case of the assessment status is in progress, the system 102 may allow to view, and delete the assessment. Additionally, in case of the assessment status is not started, the system 102 may allow to run assessment, view, and delete the assessment.

Further, if the project 804 is completed and at least one option is selected such as run assessment, view dashboard, download report, view, and delete the assessment, the system 102 may display a project dashboard 816. The system 102 may display output of the metric computation, a model performance, a data fairness, and a model fairness. The user may download the report 818 in at least one format such as, for example, a Json, a PDF, and the like.

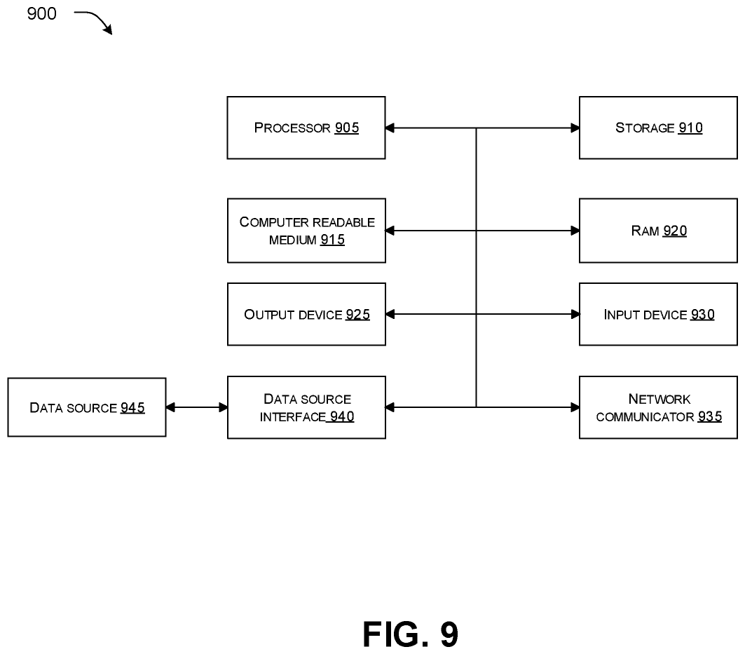

FIG. 9 illustrates an exemplary block diagram representation of a hardware platform 900 for implementation of the disclosed system 102, in accordance with embodiments of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform 900. As illustrated, the hardware platform 900 may include additional components not shown, and some of the components described may be removed and/or modified. For example, a computer system with multiple GPUs may be located on external-cloud platforms including amazon web Services® (AWS), internal corporate cloud computing clusters, or organizational computing resources.

The hardware platform 900 may be a computer system such as the system 102 that may be used with the embodiments described herein. The computer system may represent a computational platform that includes components that may be in a server or another computer system. The computer system may be executed by the processor 905 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., random access memory (RAM), read-only memory (ROM), erasable, programmable ROM (EPROM), electrically erasable, programmable ROM (EEPROM), hard drives, and flash memory). The computer system may include the processor 905 that executes software instructions or code stored on a non-transitory computer-readable storage medium 915 to perform methods of the present disclosure. The software code includes, for example, instructions to gather data and analyze the data. For example, the plurality of modules 114 include a dataset ingestion module 206, an artificial intelligence (AI)-based dataset generating module 208, a Metrix generating module 210, a mitigation determining module 212, and a continuous learning module 214.

The instructions on the computer-readable storage medium 915 are read and stored the instructions in storage 915 or random-access memory (RAM). The computer-readable storage medium 915 may provide a space for keeping static data where at least some instructions could be stored for later execution. The stored instructions may be further compiled to generate other representations of the instructions and dynamically stored in the RAM such as RAM 920. The processor 905 may read instructions from the RAM 920 and perform actions as instructed.

The computer system may further include the output device 925 to provide at least some of the results of the execution as output including, but not limited to, visual information to users, such as external agents. The output device 925 may include a display on computing devices and virtual reality glasses. For example, the display may be a mobile phone screen or a laptop screen. GUIs and/or text may be presented as an output on the display screen. The computer system may further include an input device 930 to provide a user or another device with mechanisms for entering data and/or otherwise interacting with the computer system. The input device 930 may include, for example, a keyboard, a keypad, a mouse, or a touchscreen. Each of these output devices 925 and input device 930 may be joined by one or more additional peripherals. For example, the output device 925 may be used to display the results such as bot responses by the executable chatbot.

A network communicator 935 may be provided to connect the computer system to a network and in turn to other devices connected to the network including other clients, servers, data stores, and interfaces, for example. A network communicator 935 may include, for example, a network adapter such as a LAN adapter or a wireless adapter. The computer system may include a data sources interface 940 to access the data source interface 945. The data source interface 945 may be an information resource. As an example, a database of exceptions and rules may be provided as the data source interface 945. Moreover, knowledge repositories and curated data may be other examples of the data source interface 945.

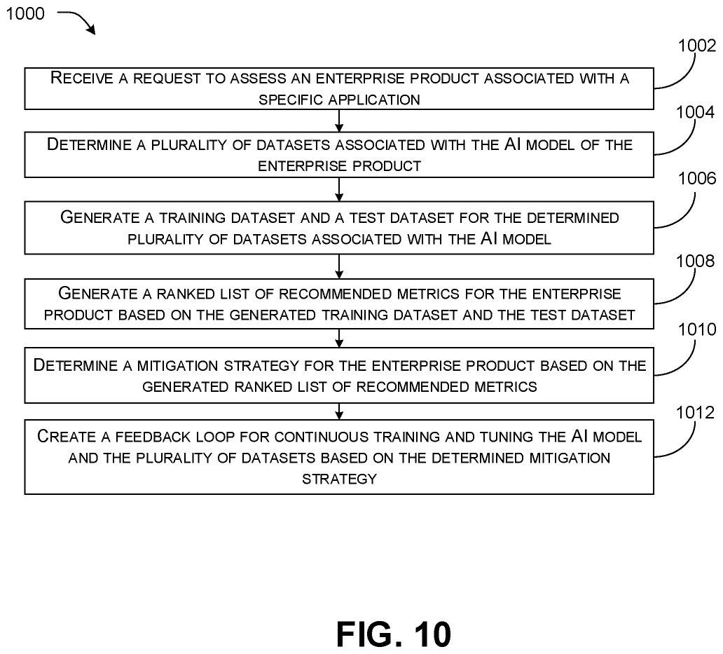

FIG. 10 illustrates a flow chart depicting a method 1000 of intelligent and continuous responsible AI compliance and governance management in AI Products, in accordance with the embodiments of the present disclosure.

At block 1002, the method 1000 may include receiving, by one or more processors 110, a request to assess an enterprise product associated with a specific application. The request includes an artificial intelligence (AI) model, initial information and a metadata associated with the enterprise product. The metadata may include geographic region, technology tech stack, people responsible for the assessment, and the like.

At block 1004, the method 1000 may include determining, by the one or more processors 110, a plurality of datasets associated with the AI model of the enterprise product. The plurality of datasets include a plurality of attributes and protected groups within the plurality of datasets.

At block 1006, the method 1000 may include generating, by the one or more processors 110, a training dataset and a test dataset for the determined plurality of datasets associated with the AI model. The training dataset and the test dataset includes an expanded training dataset and a classified test dataset.

At block 1008, the method 1000 may include generating, by the one or more processors 110, a ranked list of recommended metrics for the enterprise product based on the generated training dataset and the test dataset and historical information on similar products in functional area previously evaluated; wherein the ranked list of recommended metrics is generated in order of relevancy.

At block 1010, the method 1000 may include determining, by the one or more processors 110, a mitigation strategy for the enterprise product based on the generated ranked list of recommended metrics and historical data of previously remediated solutions in similar functional areas and regions. The mitigation strategy comprises a remediation recommendation comprising a list of ranked remediation steps for the enterprise product with effort scores, re-selected datasets, and re-trained models.

At block 1012, the method 1000 may include creating, by the one or more processors 110, a feedback loop for continuous training and tuning the AI model and the plurality of datasets based on the determined mitigation strategy.

The method 1000 may be implemented in any suitable hardware, software, firmware, or combination thereof. The order in which the method 1000 is described is not intended to be construed as a limitation, and any number of the described method blocks may be combined or otherwise performed in any order to implement the method 1000 or an alternate method. Additionally, individual blocks may be deleted from the method 1000 without departing from the spirit and scope of the present disclosure described herein. Furthermore, the method 1000 may be implemented in any suitable hardware, software, firmware, or a combination thereof, that exists in the related art or that is later developed. The method 1000 describes, without limitation, the implementation of the system 102. A person of skill in the art will understand that method 1000 may be modified appropriately for implementation in various manners without departing from the scope and spirit of the disclosure.

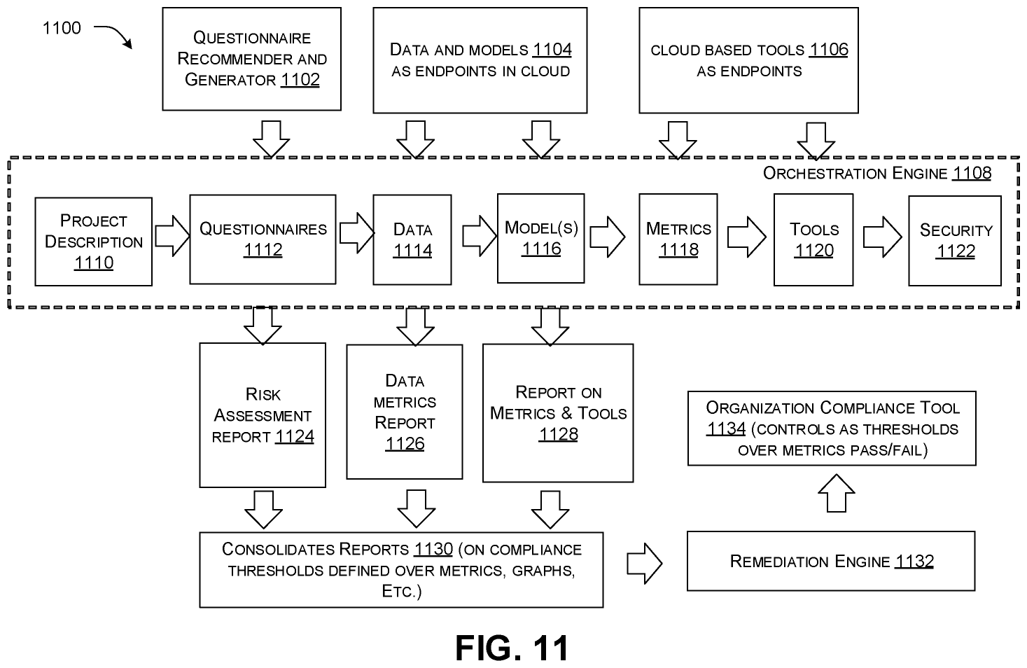

FIG. 11 illustrates an exemplary flow diagram representation of RAI product assessment process 1100, in accordance with embodiments of the present disclosure. In an embodiment, a questionnaire recommender and generator module 1102 recommends question based on RAI dimensions using an AI questionnaire model, and generates relating questions to the recommended questions using a generative AI model. Further, the data and models 1104 are retrieved from the database as endpoints. Also, any cloud based or open source or third party-based metrics and tools 1106 are retrieved as endpoints. The questionnaires, data, models and metrics are then fed to the orchestration engine 1108. The orchestration engine 1108 retrieves project description 1110, questionnaires 1112, data 1114, models 1116, metrics 1118, tools 1120, and security features 1122 associated with an AI product that is to assessed. Further, the orchestration engine 1108 generates a risk assessment report 1124, a report on data metrics 1126, and a report on metrics and tools 1128 for model inputs and outputs. Further, the orchestration engine 1108 generates a consolidated report 1130 on compliance thresholds defined over metrics, graphs, and the like based on the risk assessment report 1124, the report on data metrics 1126, and the report on metrics and tools 1128 for model inputs and outputs. The consolidated report 1130 is then used by the remediation engine 1132 to determine mitigation strategies which is then fed to the organization compliance tool 1134. The organization compliance tool 1134 comprises control functions as threshold over metrics pass or fail result.

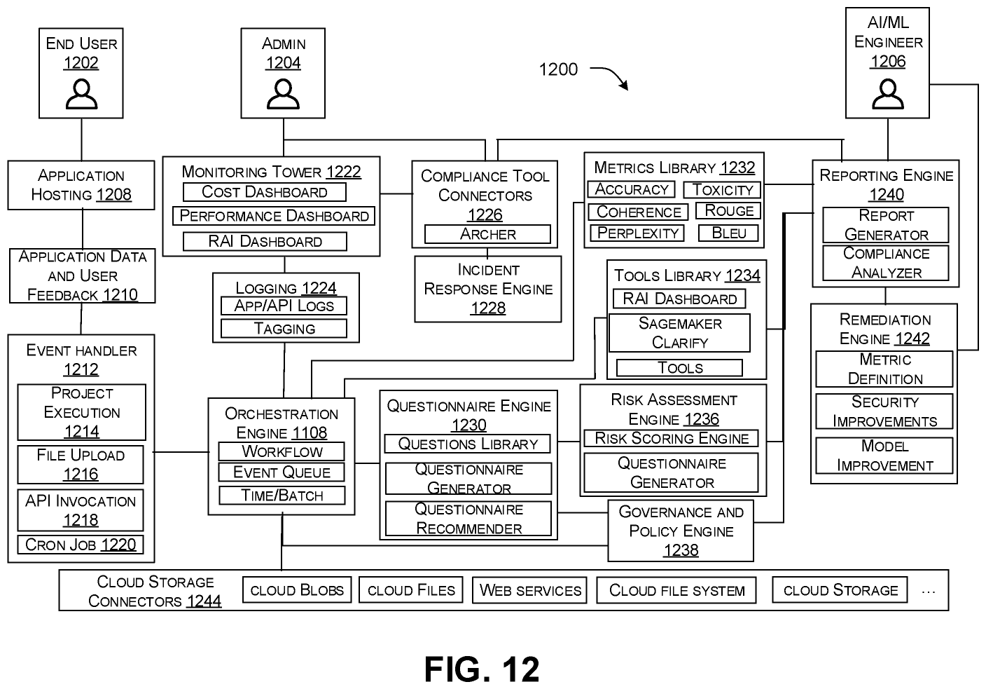

FIG. 12 illustrates an exemplary block diagram of an RAI assessment reference architecture 1200, in accordance with embodiments of the present disclosure. The architecture 1200 includes an end user 1202, an admin 1204, and an AI/ML engineer 1206 roles. The end user 1202 is provided with application hosting 1208, application data and user feedback 1210 and event handler 1212 controls. The event handler 1212 further provides project execution 1214, file upload 1216, API invocation 1218, and cron job 1220 controls. The admin 1204 is provided with monitoring tower 1222, logging 1224, orchestration engine 1108, compliance tool connectors 1226, incident response engine 1226, and questionnaire engine 1230. The monitoring tower 1222 control comprises a cost dashboard, a performance dashboard and an RAI dashboard. The logging 1224 comprises application or API logs, and tagging. The orchestration engine 1108 comprises workflow, event queue and real-time or batch control. The compliance tool connectors 1226 comprise archer. The orchestration engine 1108 is communicatively connected to the event handler 1212, a metrics library 1232, a questionnaire engine 1230 and a tools library 1234. The questionnaire engine 1230 comprises questions library, questionnaire generator, and a questionnaire recommender. The metrics library 1232 comprises accuracy, coherence, toxicity, rouge, perplexity, and bleu. The tools library 1234 comprises cloud RAI dashboard, cloud sage maker clarify, and other tools. The risk assessment engine 1236 comprises risk scoring engine, and the questionnaire generator. The governance and policy engine 1238 is connected to the orchestration engine 1108 and the reporting engine 1240. The output of the orchestration engine 1108 is connected to a plurality of cloud connectors 1244. The AI/ML engineer 1206 is provided with reporting engine 1240 and a remediation engine 1242. The reporting engine 1240 comprises a report generator and a compliance analyzer. The remediation engine 1242 comprises a metric definition, security improvements, and model improvements control. The plurality of connectors 1244 comprises cloud blobs, cloud files, web services, cloud file system, cloud storage and the like.

The present disclosure provides a system and method for responsible AI compliance and governance management in AI Products. The present system assesses the training data and AI models in several dimensions needed to create responsible AI systems such as data and model fairness, model performance and intelligibility. The present system further supports creation of questionnaires to assess RAI subjective metrics automatically using AI. Further, the present system allows to create assessment projects where AI scientists select the metrics used to evaluate the data and model(s) and once the assessment is executed, these metrics are visualized in dashboards. These metrics serve as feedback for product managers and the AI scientists to improve on quality of the AI solutions. Furthermore, new metrics may be added to the present system on the fly without having to go back to development. AI is leveraged to suggest new metrics depending on the functional area of the AI solutions and to find the optimal data and models to be used for a particular application.

For generative AI models, plurality of assessment flows such as AI detectors are created to remove different types of inaccurate data (for example, profanity, self-harm, racism, violence, and the like.) from the training dataset and to moderate large language model (LLM) inputs and outputs with respect to inaccuracy. The present system respects data confidentiality of models under test as only containers are used and there is no code that needs to be shared. The present system has a standard metrics and model representation design to support different types of models such as, for example, but not limited to, regression, text classification, image classification, information extraction models, LLMs, and the like.

The present system provides governance and monitoring of objective and subjective responsible AI metrics under one roof. The present system leverages AI to self-monitor and uses continuous evaluation of an AI product in production to monitor the RAI metrics for compliance while respecting the data confidentiality of AI algorithms. The present system supports questionnaire-based evaluations for subjective metrics in all RAI dimensions. Further, the present system uses an intelligent splitting algorithm for training dataset and test dataset to reduce inaccurate data during model training. Further, the present system generates synthetic data to overcome an inaccurate dataset before training. This helps in dataset expansion. The present system further generates abstractive insights based on model types using the metadata and historical information. Furthermore, the present system generates real-time insights for potential inaccuracy in uploaded data. Additionally, the present system generates comparative statistics for each project based on other similar projects being evaluated and generates a remediation recommendation based on the report.

The present system allows reusability by building libraries of metrics algorithms, integrations, actions and rule polices. Further, the present system reduces AI metrics development time and cost. Furthermore, the present system allows continuous learning for responsible AI which enables higher decision-making confidence. Further, the present system allows for full governance and monitoring of AI solutions implemented within an organization thus reducing risk of non-compliant AI products going into market.

The present system may apply AI-based detectors and measure metrics such as profanity, violence, and self-harm to clean up ensembles of datasets used to train generative AI algorithms. The dataset may be modified in the process, for example removing data or transforming non-desirable data into desirable data (e.g., personal identifiable information).

In an embodiment, the output of generative AI algorithms depends on previous questions asked. This is known as “prompt engineering”. The present system allows for the testing of a sequence of N prompts applied consecutively to the model and then test for an expected answer.

Further, the present system trains a generative AI algorithm over different subsets of the training dataset, or ensemble components to identify the generative AI algorithm that is optimal with respect to inaccuracy or other metrics of interest. The present system considers two different AI models, for example, from different vendors and runs a “benchmark” dataset through both and compute metrics over the models to compare them. Further, the present system compares metrics implemented by different parties and selects the best performing ones by applying them to a “benchmark” dataset and model. The present system further partitions the training dataset into train test, then computes metrics over test dataset, and passes test dataset over model and computes metrics over model output. Furthermore, the present system compiles a training dataset over time to retrain the model to improve the accuracy of the models.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A system, comprising:
a processor; and
a memory operatively coupled with the processor, wherein the memory comprises processor-executable instructions which, when executed by the processor, cause the processor to:
receive a request to assess an enterprise product associated with a specific application, wherein the request comprises at least one artificial intelligence (AI) model, initial information and a metadata associated with the enterprise product;
determine a plurality of datasets associated with the at least one AI model of the enterprise product, wherein the plurality of datasets comprise a plurality of attributes and protected groups within the plurality of datasets;
generate a training dataset and a test dataset for the determined plurality of datasets associated with the at least one AI model, wherein the training dataset and the test dataset comprises an expanded training dataset and a classified test dataset;
generate a ranked list of recommended metrics for the enterprise product based on the generated training dataset and the test dataset and historical information on similar products in a previously evaluated functional area, wherein the ranked list of recommended metrics is generated in order of relevancy;
determine a mitigation strategy for the enterprise product based on the generated ranked list of recommended metrics and historical data of previously remediated solutions in similar functional areas and regions, wherein the mitigation strategy comprises a remediation recommendation comprising a list of ranked remediation steps for the enterprise product with effort scores, re-selected datasets, and re-trained models; and
create a feedback loop for continuous training and tuning the at least one AI model and the plurality of datasets based on the determined mitigation strategy.

2. The system of claim 1, wherein the processor is to:
generate a report for the enterprise product based on the generated ranked list of recommended metrics, wherein the report comprises one of the recommended metrics, dashboard configurations, project comparisons, and mitigation options;
generate a product assessment report for the enterprise product based on the determined mitigation strategy and the generated report, wherein the product assessment report comprises product quality indicators; and
output the generated report, the determined mitigation strategy, and the generated product assessment report for the enterprise product on a user interface of a user device.

3. The system of claim 1, wherein the processor is to:
retrieve a metadata associated with the at least one AI model from a database, wherein the metadata comprises an application domain, a data size, a feature variable type, a model used, and documentation information;
compute a similarity metric score between current enterprise product and historical records of enterprise products based on the retrieved metadata;
determine a plurality of recommendations for the at least one AI model based on the computed similarity metric score using a collaborative filtering process and a content-based filtering process;
identify a list of similar AI models based on the determined plurality of recommendations;
identify similarity features mapping relevantly with each of the identified list of similar AI models based on acceptance of the identified list of similar AI models;
identify a subset of metadata associated with each of the list of similar AI models based on the identified similarity features;
execute a distance technique for each of the identified subset of metadata associated with each of the list of similar AI models; and
determine at least one AI model as recommended AI model among the list of similar AI models based on results of execution of the distance technique.

4. The system of claim 3, wherein the processor is to determine the at least one AI model as recommended AI model for the enterprise product by:
retrieving a plurality of AI models stored in the database;
extracting a metadata associated with each of the retrieved plurality of AI models, wherein the metadata comprises performance metrics, model fairness level, explainability level, a dataset size, a model dimensionality, and a memory resource; and
determining an appropriate AI model among the retrieved plurality of AI models by applying the extracted metadata to each of the retrieved plurality of AI models.

5. The system of claim 1, wherein the processor is to generate the training dataset and the test dataset for the determined plurality of datasets associated with the at least one AI model by:
eliminating target variables present in the determined plurality of datasets;
performing clustering on the determined plurality of datasets based on the plurality of attributes and the protected groups within the determined plurality of datasets;
assigning a density score to each cluster of datasets based on a set of parameters;
mapping the assigned density score and a deviation level with a predefined threshold value;
generating synthetic data samples for the cluster of datasets based on the mapped density score and the deviation level;
selecting n percentage of the test dataset from a centroid of each cluster for each of the protected groups;
recomputing density scores for expanded training dataset based on the selected n percentage of the test dataset;
comparing the recomputed density scores with the predefined threshold value;
generating the expanded training dataset and the classified test dataset upon determining that the recomputed density scores are lower than the predefined threshold value; and
repeating the steps from generating the synthetic data samples upon determining that the recomputed density scores are greater than the predefined threshold value.

6. The system of claim 1, wherein the processor is to generate the training dataset and the test dataset for the determined plurality of datasets associated with the at least one AI model by:
identifying AI detectors to be factored from the determined plurality of datasets based on the specific application;
determining a threshold value for each of the identified AI detectors;
computing an average overall compliance score by applying the plurality of datasets to each of the identified AI detectors;
identifying a compliance rectification strategy by comparing the computed average overall compliance score with the determined threshold value of each of the identified AI detectors;
performing one of a modification and an elimination of K data samples upon determining that the computed average overall compliance score is less than the compliance threshold value based on the identified rectification strategy; and
generating a filtered training dataset associated with the at least one AI model based on the performed one of the modification and the elimination.

7. The system of claim 1, wherein the processor is to generate the ranked list of recommended metrics for the enterprise product based on the generated training dataset and the test dataset by:
determining domain-specific fairness metrics for the generated training dataset and the test dataset from a metric library;
evaluating a feasibility value of applying the determined domain specific fairness metrics to the plurality of datasets based on the plurality of attributes and the protected groups within the plurality of datasets;
assigning weights to the determined domain specific fairness metrics based on results of the evaluation;
computing a composite score for the determined domain-specific fairness metrics by correlating the assigned weights with corresponding domain specific fairness metric;
mapping each of the computed composite score with a predefined threshold value;
performing bootstrap resampling to the determined domain-specific fairness metrics based on results of mapping, wherein the results of bootstrap resampling generate a bootstrap sample;
computing the domain-specific fairness metrics and a composite score for each of the bootstrap sample;
determining a mean value of the computed composite score based on at least one of a functional area and dataset, wherein the determined mean value is mapped with the predefined threshold value;
computing an ensemble metric score for each of the bootstrap sample based on results of the mapping; and
generate the ranked list of recommended metrics for the enterprise product based on the computed ensemble metric score.

8. The system of claim 1, wherein the processor is to determine the mitigation strategy for the enterprise product based on the generated report by:
determining the recommended metrics, the dashboard configurations, the project comparisons, and the mitigation options from the generated report;
generating dashboard views for the determined recommended metrics based on the dashboard configurations;
creating dashboard descriptions for the generated dashboard views using pre-stored rules;
generating a similarity score for each of pre-stored similar enterprise products, wherein the pre-stored similar products are determined using similarity metric between the current enterprise product and pre-stored enterprise products;
mapping the generated similarity score for each of the pre-stored similar enterprise products with a predefined threshold value;
generating remediation outputs for the pre-stored similar enterprise products based on results of mapping;
applying the created dashboard descriptions, and the generated remediation outputs to a generative AI model;
generating a remediation list based on results of the generative AI model;
classifying the generated remediation list into an automated task and a manual task;
triggering automatic pipelines for dataset splitting and model training based on the classified automated task and the manual task; and
generating a remediated metrics report for the enterprise product based on the triggered automatic pipelines and the generated remediation list.

9. The system of claim 1, wherein the processor is to:
evaluate the enterprise product by:
determining a functional and a sub-functional area of the enterprise product;
identifying responsible AI (RAI) dimensions required for recommending the questionnaire based on the determined functional and sub-functional area of the enterprise product;
recommending questions based on the identified RAI dimensions using an AI questionnaire model, wherein the AI questionnaire model comprises pre-stored questions; and
generating relating questions to the recommended questions using a generative AI model; and
evaluate an AI model and a dataset associated with the enterprise product based on the generated remediation recommendation and the generated report comprising the recommended metrics, wherein the AI model and the dataset are evaluated by;
comparing each of the recommended metrics with a pre-defined control metrics;
determining a risk associated with the recommended metrics based on the results of comparison, wherein the results of comparison comprise mapped metrics and un-mapped metrics; and
generating an AI based risk assessment report for the enterprise product based on the determined risk, wherein the AI based risk report comprises corrective actions to rectify the determined risk.

10. A method comprising:
receiving, by a processor, a request to assess an enterprise product associated with a specific application, wherein the request comprises at least one artificial intelligence (AI) model, initial information and a metadata associated with the enterprise product;
determining, by the processor, a plurality of datasets associated with the at least one AI model of the enterprise product, wherein the plurality of datasets comprise a plurality of attributes and protected groups within the plurality of datasets;
generating, by the processor, a training dataset and a test dataset for the determined plurality of datasets associated with the at least one AI model, wherein the training dataset and the test dataset comprises an expanded training dataset and a classified test dataset;
generating, by the processor, a ranked list of recommended metrics for the enterprise product based on the generated training dataset and the test dataset and historical information on similar products in a previously evaluated functional area; wherein the ranked list of recommended metrics is generated in order of relevancy;
determining, by the processor, a mitigation strategy for the enterprise product based on the generated ranked list of recommended metrics and historical data of previously remediated solutions in similar functional areas and regions, wherein the mitigation strategy comprises a remediation recommendation comprising a list of ranked remediation steps for the enterprise product with effort scores, re-selected datasets, and re-trained models; and
creating, by the processor, a feedback loop for continuous training and tuning the at least one AI model and the plurality of datasets based on the determined mitigation strategy.

11. The method of claim 10, further comprising:
generating, by the processor, a report for the enterprise product based on the generated ranked list of recommended metrics, wherein the report comprises one of the recommended metrics, dashboard configurations, project comparisons, and mitigation options;
generating, by the processor, a product assessment report for the enterprise product based on the determined mitigation strategy and the generated report, wherein the product assessment report comprises product quality indicators; and
outputting, by the processor, the determined mitigation strategy, and the generated product assessment report for the enterprise product on a user interface of a user device.

12. The method of claim 10, further comprising:
retrieving, by the processor, a metadata associated with the at least one AI model from a database, wherein the metadata comprises an application domain, a data size, a feature variable type, a model used, and documentation information;
computing, by the processor, a similarity metric score between current enterprise product and historical records of enterprise products based on the retrieved metadata;
determining, by the processor, a plurality of recommendations for the at least one AI model based on the computed similarity metric score using a collaborative filtering process and a content-based filtering process;
identifying, by the processor, a list of similar AI models based on the determined plurality of recommendations;
identifying, by the processor, similarity features mapping relevantly with each of the identified list of similar AI models based on acceptance of the identified list of similar AI models;
identifying, by the processor, a subset of metadata associated with each of the list of similar AI models based on the identified similarity features;
executing, by the processor, a distance technique for each of the identified subset of metadata associated with each of the list of similar AI models; and
determining, by the processor, at least one AI model as recommended AI model among the list of similar AI models based on results of execution of the distance technique.

13. The method of claim 12, wherein determining at least one AI model as recommended AI model for the enterprise product comprises:
retrieving, by the processor, a plurality of AI models stored in a database;
extracting, by the processor, a metadata associated with each of the retrieved plurality of AI models, wherein the metadata comprises performance metrics, model fairness level, explainability level, a dataset size, a model dimensionality, and a memory resource; and
determining, by the processor, an appropriate AI model among the retrieved plurality of AI models by applying the extracted metadata to each of the retrieved plurality of AI models.

14. The method of claim 10, wherein generating the training dataset and the test dataset for the determined plurality of datasets associated with the AI model comprises:
eliminating, by the processor, target variables present in the determined plurality of datasets;
performing, by the processor, clustering on the determined plurality of datasets based on the plurality of attributes and the protected groups within the determined plurality of datasets;
assigning, by the processor, a density score to each cluster of datasets based on a set of parameters;
mapping, by the processor, the assigned density score and a deviation level with a predefined threshold value;
generating, by the processor, synthetic data samples for the cluster of datasets based on the mapped density score and the deviation level;
selecting, by the processor, n percentage of the test dataset from a centroid of each cluster for each of the protected groups;
recomputing, by the processor, density scores for expanded training dataset based on the selected n percentage of the test dataset;
comparing, by the processor, the recomputed density scores with the predefined threshold value;
generating, by the processor, the expanded training dataset and the classified test dataset upon determining that the recomputed density scores are lower than the predefined threshold value; and
repeating, by the processor, the steps from generating the synthetic data samples upon determining that the recomputed density scores are greater than the predefined threshold value.

15. The method of claim 10, wherein generating the training dataset and the test dataset for the determined plurality of datasets associated with the at least one AI model comprises:
identifying, by the processor, AI detectors to be factored from the determined plurality of datasets based on the specific application;
determining, by the processor, a threshold value for each of the identified AI detectors;
computing, by the processor, an average overall compliance score by applying the plurality of datasets to each of the identified AI detectors;
identifying, by the processor, a compliance rectification strategy by comparing the computed average overall compliance score with the determined threshold value of each of the identified AI detectors;
performing, by the processor, one of a modification and an elimination of K data samples upon determining that the computed average overall compliance score is less than the compliance threshold value based on the identified rectification strategy; and
generating, by the processor, a filtered training dataset associated with the AI model based on the performed one of the modification and the elimination.

16. The method of claim 10, wherein generating the ranked list of recommended metrics for the enterprise product based on the generated training dataset and the test dataset comprises:
determining, by the processor, domain-specific fairness metrics for the generated training dataset and the test dataset from a metric library;
evaluating, by the processor, feasibility value of applying the determined domain specific fairness metrics to the plurality of datasets based on the plurality of attributes and the protected groups within the plurality of datasets;
assigning, by the processor, weights to the determined domain specific fairness metrics based on results of the evaluation;
computing, by the processor, a composite score for the determined domain-specific fairness metrics by correlating the assigned weights with corresponding domain specific fairness metric;
mapping, by the processor, each of the computed composite score with a predefined threshold value;
performing, by the processor, bootstrap resampling to the determined domain-specific fairness metrics based on results of mapping, wherein the results of bootstrap resampling generate a bootstrap sample;
computing, by the processor, the domain-specific fairness metrics and a composite score for each of the bootstrap sample;
determining, by the processor, a mean value of the computed composite score, wherein the determined mean value is mapped with the predefined threshold value;
computing, by the processor, an ensemble metric score for each of the bootstrap sample based on results of the mapping; and
generating, by the processor, the ranked list of recommended metrics for the enterprise product based on the computed ensemble metric score.

17. The method of claim 10, wherein determining the mitigation strategy for the enterprise product based on the generated report comprises:
determining, by the processor, the recommended metrics, the dashboard configurations, the project comparisons, and the mitigation options from the generated report;
generating, by the processor, dashboard views for the determined recommended metrics based on the dashboard configurations;
creating, by the processor, dashboard descriptions for the generated dashboard views using pre-stored rules;
generating, by the processor, a similarity score for each of pre-stored similar enterprise products, wherein the pre-stored similar products are determined using similarity metric between the current enterprise product and pre-stored enterprise products;
mapping, by the processor, the generated similarity score for each of the pre-stored similar enterprise products with a predefined threshold value;
generating, by the processor, remediation outputs for the pre-stored similar enterprise products based on results of mapping;
applying, by the processor, the created dashboard descriptions and the generated remediation outputs to a generative AI model;
generating, by the processor, a remediation list based on results of the generative AI model;
classifying, by the processor, the generated remediation list into an automated task and a manual task;
triggering, by the processor, automatic pipelines for dataset splitting and model training based on the classified automated task and the manual task; and
generating, by the processor, a remediated metrics report for the enterprise product based on the triggered automatic pipelines and the generated remediation list.

18. The method of claim 10, further comprising:
determining, by the processor, a functional and a sub-functional area of the enterprise product;
identifying, by the processor, responsible AI (RAI) dimensions required for recommending the questionnaire based on the determined functional and sub-functional area of the enterprise product;
recommending, by the processor, questions based on the identified RAI dimensions using an AI questionnaire model, wherein the AI questionnaire model comprises pre-stored question;
generating, by the processor, relating questions to the recommended questions using a generative AI model; and
evaluating, by the processor, the enterprise product based on the recommended questions and generated related questions.

19. The method of claim 10, further comprising:
evaluating, by the processor, an AI model and a dataset associated with the enterprise product based on the generated remediation recommendation and the generated report comprising the recommended metrics, wherein the AI model and the dataset are evaluated by;
comparing, by the processor, each of the recommended metrics with a pre-defined control metrics;
determining, by the processor, a risk associated with the recommended metrics based on the results of comparison, wherein the results of comparison comprise mapped metrics and un-mapped metrics; and
generating, by the processor, an AI based risk assessment report for the enterprise product based on the determined risk, wherein the AI based risk report comprises corrective actions to rectify the determined risk.

20. A non-transitory computer readable medium comprising a processor-executable instructions that cause a processor to:
receive a request to assess an enterprise product associated with a specific application, wherein the request comprises at least one artificial intelligence (AI) model, initial information and a metadata associated with the enterprise product;
determine a plurality of datasets associated with the at least one AI model of the enterprise product, wherein the plurality of datasets comprises a plurality of attributes and protected groups within the plurality of datasets;
generate a training dataset and a test dataset for the determined plurality of datasets associated with the at least one AI model, wherein the training dataset and the test dataset comprises an expanded training dataset and a classified test dataset;
generate a ranked list of recommended metrics for the enterprise product based on the generated training dataset and the test dataset and historical information on similar products in a previously evaluated functional area; wherein the ranked list of recommended metrics is generated in order of relevancy;
determine a mitigation strategy for the enterprise product based on the generated ranked list of recommended metrics and historical data of previously remediated solutions in similar functional areas and regions, wherein the mitigation strategy comprises a remediation recommendation comprising a list of ranked remediation steps for the enterprise product with effort scores, re-selected datasets, and re-trained models; and
create a feedback loop for continuous training and tuning the at least one AI model and the plurality of datasets based on the determined mitigation strategy.
